(19) United States
(12) Patent Application Publication
(10) Pub. No.: US 2026/0270040 A1
(43) Pub. Date: Sep. 10, 2026

(54) CONTINUOUS SYNCHRONIZATION SIGNALING FOR CRYSTAL-LESS COMMUNICATION LINKS

(71) Applicant: Infineon Technologies Americas Corp., EI Segundo, CA (US)

(72) Inventors: Seid Alireza Razavi Majomard, Belmont, CA (US); Ragnar Jonsson, Aliso Viejo, CA (US); Aleksei Zherebtsov, Karlsruhe (DE); Samuel Johnson, Frisco, TX (US)

(73) Assignee: Infineon Technologies Americas Corp., EI Segundo, CA (US)

(21) Appl. No.: 19/557,614

(22) Filed: Mar. 5, 2026

Related U.S. Application Data
(60) Provisional application No. 63/805,174, filed on May 13, 2025.
(60) Provisional application No. 63/797,437, filed on Apr. 30, 2025.
(60) Provisional application No. 63/768,162, filed on Mar. 6, 2025.

(51) Int. Cl. H04L 7/00; H04L 5/00

(52) U.S. Cl. CPC H04L 7/0016; H04L 5/0055; H04L 7/0054

(57) ABSTRACT

Methods for continuous link synchronization and training for communication links are provided herein. A method comprises receiving, by a first physical layer device, a continuous synchronization signal from a second physical layer device, wherein the continuous synchronization signal omits quiet periods between successive synchronization transmissions. The method further comprises extracting clock information from the continuous synchronization signal using timing recovery circuitry. The method further comprises deriving timing from the continuous synchronization signal to compensate for a frequency offset relative to the second physical layer device, wherein the timing recovery circuitry performs clock extraction during both synchronization and data transmission phases. The method further comprises transmitting a synchronization response to the second physical layer device using timing derived from the extracted clock information. Apparatuses for link synchronization are also provided.

### CROSS-REFERENCE TO RELATED APPLICATIONS

This application claims priority to U.S. Provisional Application No. 63/768,162, titled “Link Synchronization for Crystal-Less Camera Links,” filed March 6, 2025, which is hereby incorporated by reference in its entirety; U.S. Provisional Application No. 63/797,437, titled “Link Synchronization for Crystal-Less Camera Links,” filed April 30, 2025, which is hereby incorporated by reference in its entirety; and U.S. Provisional Application No. 63/805,174, titled “Joint Link Synchronization and Training for Camera Links,” filed May 13, 2025, which is hereby incorporated by reference in its entirety.

### FIELD OF INVENTION

The present disclosure relates to communication link synchronization in networking systems, and more particularly to methods and apparatus for link synchronization and training in communication link configurations where communicating devices exhibit substantial clock variations.

### BACKGROUND

Communication links in networking systems connect physical layer devices such as, but not limited to, sensors, cameras, or other communicating devices to processing units including switches or electronic control units. Devices on opposite ends of such communication links coordinate a startup process to ensure that both sides are ready to begin training and data transmission. In configurations where physical layer devices lack crystal oscillators, clock variations between communicating devices may become substantial, presenting challenges for link synchronization.

### BRIEF DESCRIPTION OF THE DRAWINGS

FIG. 1 illustrates a block diagram of a leader device configured for link synchronization, according to aspects of the present disclosure.

FIG. 2 illustrates a block diagram of a follower device configured for link synchronization, according to aspects of the present disclosure.

FIGS. 3A–3C illustrate flowcharts for methods of link synchronization in a communication system, according to aspects of the present disclosure.

FIG. 4 illustrates a sequence diagram representing a link synchronization process between a leader device and a follower device, according to aspects of the present disclosure.

FIG. 5 illustrates a sequence diagram representing link synchronization between two physical layer devices, according to aspects of the present disclosure.

FIG. 6 illustrates a frame structure depicting signal framing for link synchronization and training, according to aspects of the present disclosure.

FIG. 7 illustrates a flowchart for a method of link synchronization from the perspective of a follower device, according to aspects of the present disclosure.

FIG. 8 illustrates a flowchart for a method of link synchronization from the perspective of a leader device, according to aspects of the present disclosure.

FIG. 9 illustrates a timing diagram representing signal exchanges during link synchronization, according to aspects of the present disclosure.

FIG. 10 illustrates a link synchronization diagram representing interactions between a leader device and a follower device, according to aspects of the present disclosure.

FIG. 11 illustrates a timing diagram representing link synchronization between a leader device and a follower device, according to aspects of the present disclosure.

FIG. 12 illustrates a sequence diagram representing a link synchronization process between a leader device and a follower device, according to aspects of the present disclosure.

### DETAILED DESCRIPTION

Communication links connect devices such as cameras, sensors, or other peripherals to processing units such as switches or electronic control units. Before these devices can exchange data, they must coordinate a startup process to ensure both sides are ready. An initial stage of this startup process is referred to as link synchronization. During link synchronization, each device confirms the presence of the other and establishes timing alignment so the receiver can correctly interpret transmitted signals. Following link synchronization, devices may enter a training phase. As used herein, “training” refers to a phase where devices adjust their receivers to properly interpret incoming signals, which may occur after synchronization and before data transmission begins.

Several technical considerations arise in this context. Receivers typically employ matched filter detectors, which identify signals by correlating received signals against expected signal patterns. These detectors expect signals with predictable timing characteristics. Crystal oscillators provide precise timing references that enable such predictable characteristics, but crystal oscillators add cost, consume board space, and increase power consumption. Eliminating crystal oscillators is therefore attractive for resource-constrained or cost-sensitive applications such as automotive cameras.

However, eliminating crystal oscillators from such devices, also referred to herein as “physical layer devices” because they transmit and receive signals over a physical communication medium, introduces several challenges. First, a frequency offset (also referred to as a clock offset) between communicating devices may become substantial, causing matched filter detectors to fail when attempting to detect link synchronization signals. This failure may occur because the frequency offset distorts the received signal relative to an expected signal pattern, preventing reliable detection. Second, sparse signaling patterns, where a device transmits a presence indication followed by a quiet period and then repeats, may create an open-loop feedback mechanism. In such mechanisms, a first device transmits a synchronization signal, a second device responds with an acknowledgment, and the first device assumes synchronization is complete without confirming receipt of the acknowledgment. If channel noise corrupts the acknowledgment, the first device remains waiting while the second device proceeds, causing a synchronization failure. Third, maintaining separate signal structures and hardware for link synchronization, training, and data modes may increase implementation complexity and cost, particularly on resource-constrained devices where physical constraints may create pressure to reduce component count and board size.

The present disclosure provides methods and apparatuses for link synchronization in communication link systems where clock variations between communicating devices may be substantial. In some embodiments, a first physical layer device (also referred to herein as a follower device) receives a continuous synchronization signal from a second physical layer device (also referred to herein as a leader device). The continuous synchronization signal omits quiet periods between successive synchronization transmissions. In some embodiments, the continuous synchronization signal employs a symbol rate equal to that used during data transmission. The first physical layer device uses timing recovery circuitry to extract clock information from the continuous synchronization signal and derives timing from the extracted clock information to compensate for a frequency offset relative to the second physical layer device. The first physical layer device then transmits a synchronization response to the second physical layer device using the derived timing. In embodiments where the synchronization signal employs the same symbol rate and encoding as data mode, the system may eliminate dedicated link synchronization detection hardware, allowing the same timing recovery circuitry used for data mode to perform clock extraction during both synchronization and data transmission phases. Additionally, embodiments of the present disclosure may provide closed-loop acknowledgment during link synchronization, wherein the second physical layer device notifies the first physical layer device upon successful receipt of a synchronization response.

As used herein, “continuous synchronization signal” refers to a synchronization signal that a device transmits without quiet periods between successive transmissions, such that the device transmits the signal without interruption during the synchronization phase. As used herein, “timing recovery circuitry” refers to circuitry configured to extract clock information from a received signal and derive timing therefrom, including but not limited to clock and data recovery circuits, phase-locked loops, phase detectors, loop filters, and digital timing recovery loops. As used herein, “frequency offset” refers to the difference in clock frequency between communicating devices, which in crystal-less configurations may reach substantial levels due to the absence of a quartz crystal oscillator providing precise timing. As used herein, “frequency offset tolerance” refers to the maximum frequency offset at which the timing recovery circuitry can successfully extract clock information and derive timing from the continuous synchronization signal. As used herein, “acknowledgment indication” refers to a signal or bit transition that confirms receipt of a synchronization response, thereby providing closed-loop feedback during link synchronization. As used herein, “clock lock” refers to a state where timing recovery circuitry has successfully synchronized to the timing of a received signal, enabling reliable data reception. As used herein, “information field” refers to a designated portion of a transmitted signal that carries status or control information, such as an indication of synchronization state. As used herein, “clock recovery” refers to the process by which a receiving device extracts clock information from a received signal and derives timing therefrom, encompassing both the extraction of clock information and the derivation of timing to compensate for frequency offset.

As used herein, “data-mode scrambler” refers to a scrambler used during data transmission mode to randomize data patterns, and which in the present disclosure is also used to scramble zeros for generating the continuous synchronization signal. Scrambling zeros produces a varying signal pattern that enables timing recovery circuitry to extract clock information, whereas transmitting unscrambled zeros produces a constant signal from which some timing recovery circuitry cannot extract timing. The term “symbol rate” refers to the rate at which a device transmits symbols, and the continuous synchronization signal employs a symbol rate equal to that used during data transmission, allowing the device to use the same timing recovery circuitry for both synchronization and data modes. As used herein, “crystal-less” refers to a configuration in which a device lacks a local crystal oscillator and derives operational timing from a received signal rather than from a local precision clock reference.

As used herein, “differential Manchester encoding” refers to an encoding method that may be employed as an alternative to pulse amplitude modulation with two levels (PAM-2) signaling approaches used in various communication standards, where the signal uses transitions to represent data rather than signal levels, which helps receivers extract timing information from the signal. As used herein, “pseudo-random binary sequence generator” or “PRBS generator” refers to a generator that produces a predictable pattern of bits that appears random, but a receiver can reproduce if it knows the starting point (seed), allowing the receiver to predict what symbols should come next and verify correct reception. As used herein, “training signal” refers to a signal transmitted during the training phase to enable receiver adjustment, which in the present disclosure may also serve as the continuous synchronization signal.

The continuous synchronization signaling, unified signal structure, and closed-loop acknowledgment described herein address the technical challenges identified above. First, the continuous synchronization signal enables the timing recovery circuitry to extract clock information and derive timing at frequency offsets of up to 20% or more, making the approach applicable to configurations with substantial clock variations. Second, transmitting the synchronization signal at the same symbol rate and encoding as data mode eliminates the need for dedicated link synchronization detection hardware, reducing component count and cost on resource-constrained devices. Third, the closed-loop acknowledgment mechanism may prevent synchronization failures that could otherwise occur when channel noise corrupts acknowledgments. The second physical layer device may signal the acknowledgment indication by changing a specific bit in an information field of the transmitted signal, which the first physical layer device monitors to confirm synchronization is complete. Additionally, the unified signal structure supports link synchronization, training, and data modes with consistent signal characteristics, reducing implementation complexity and startup latency. In asymmetric configurations, where devices transmit and receive data at different rates, a follower device may complete training and begin receiving data while the leader device is still training. The follower device continues transmitting a follower training signal to enable the leader device to complete physical medium attachment layer training, including clock and data recovery acquisition, timing recovery, equalizer training, and/or echo cancellation, thereby reducing overall system startup time.

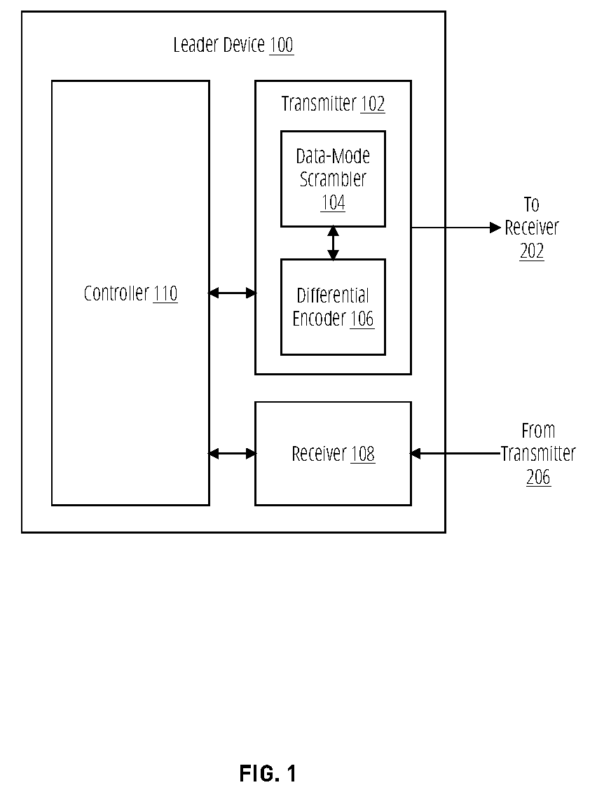

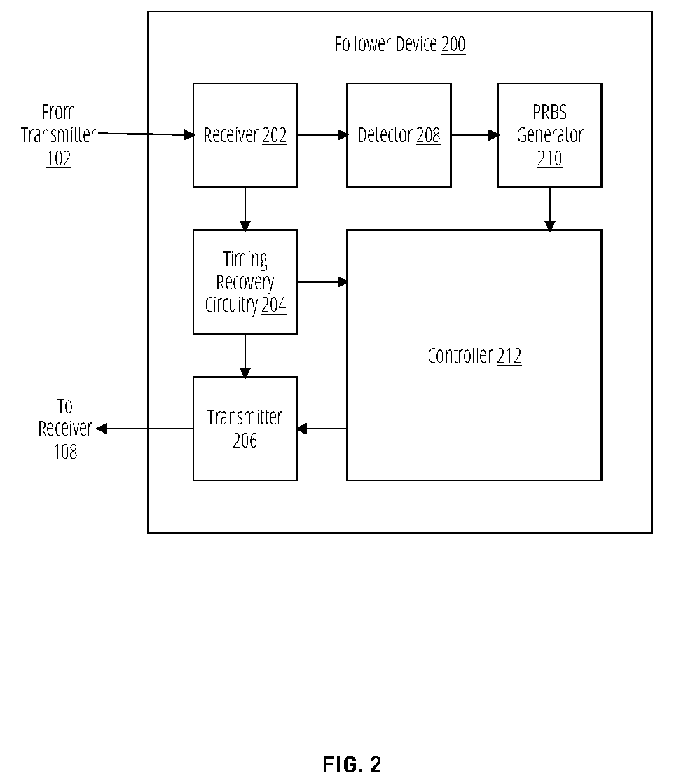

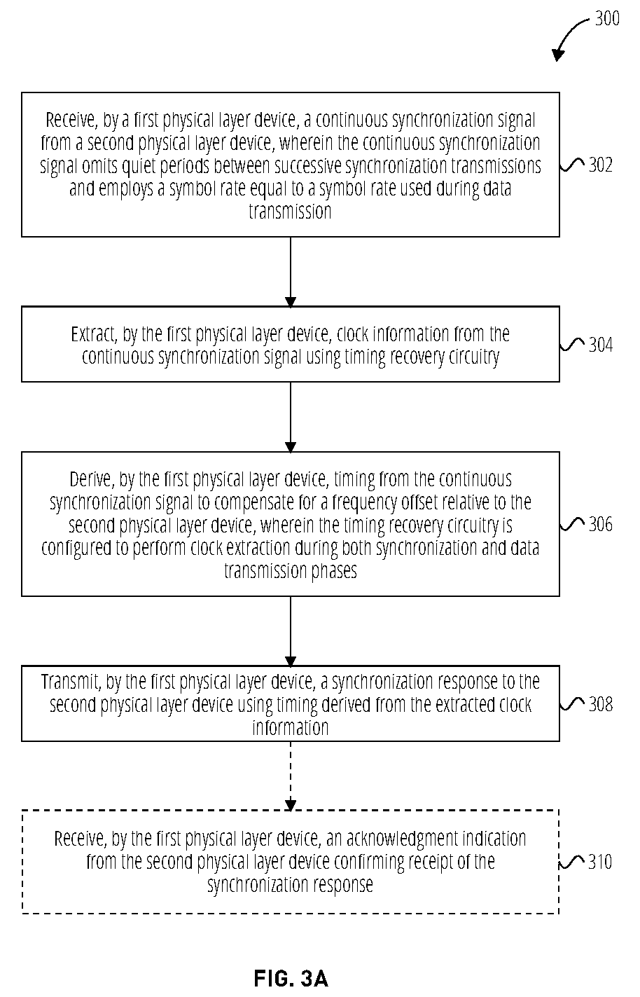

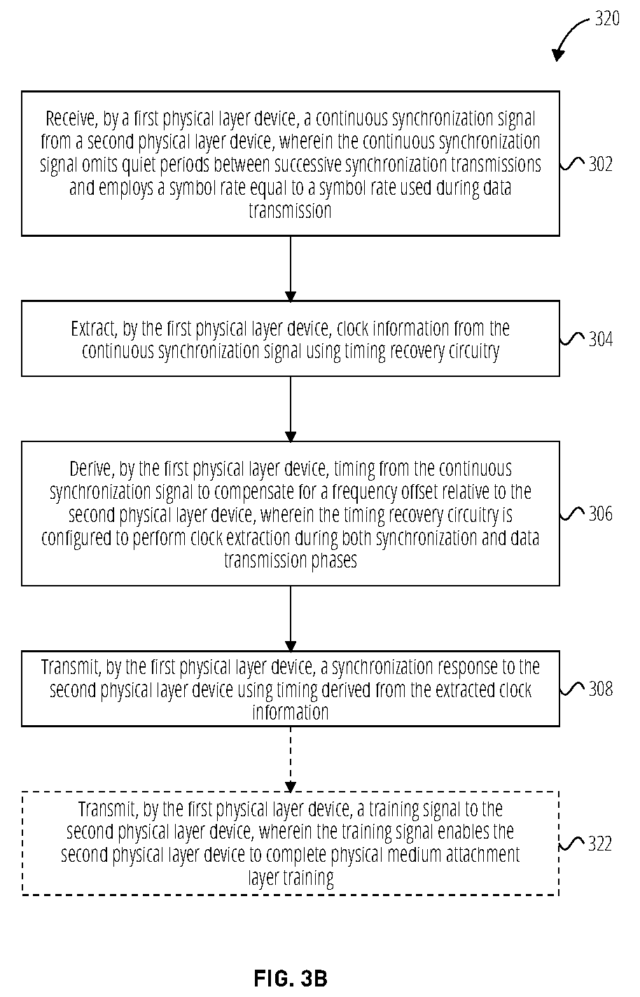

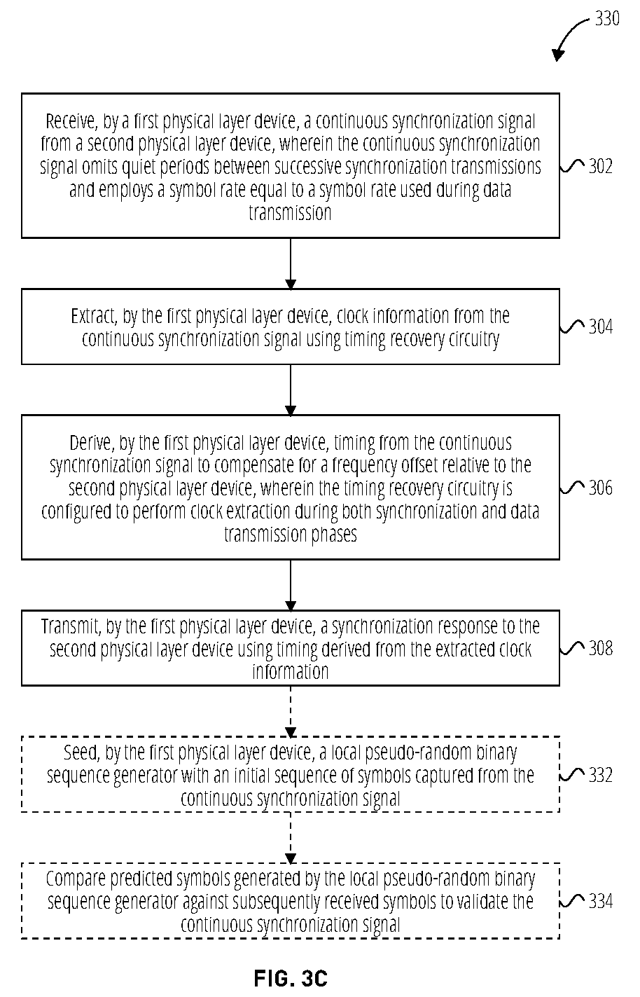

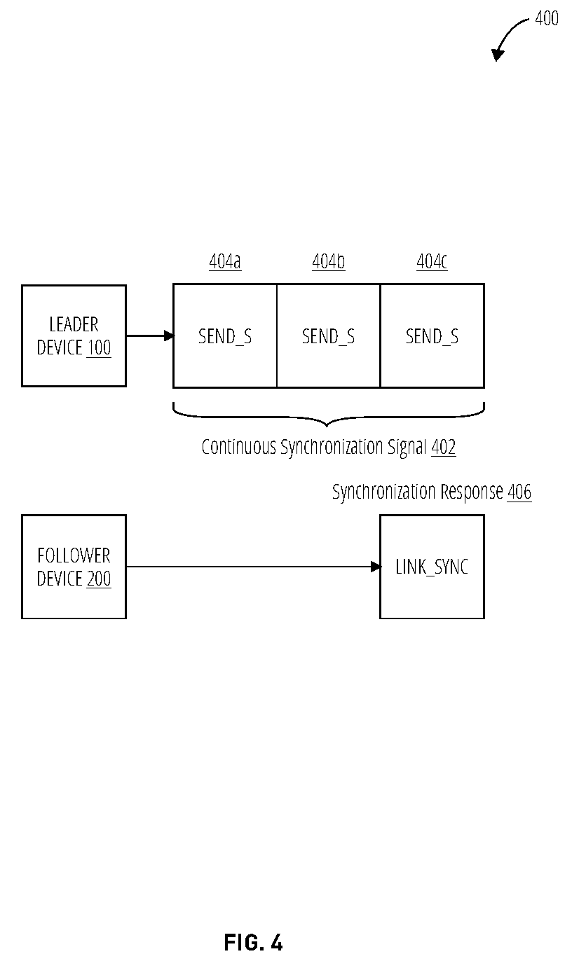

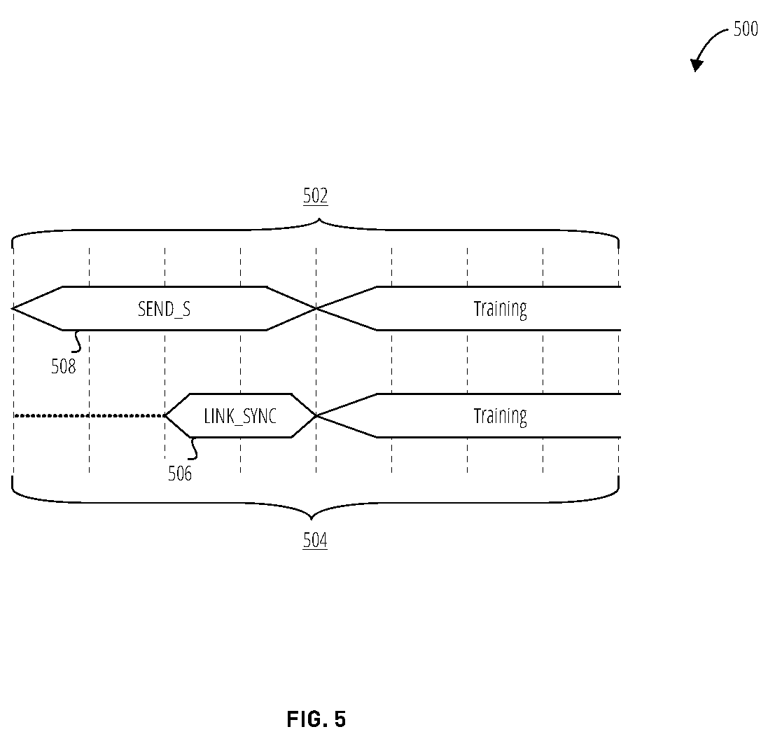

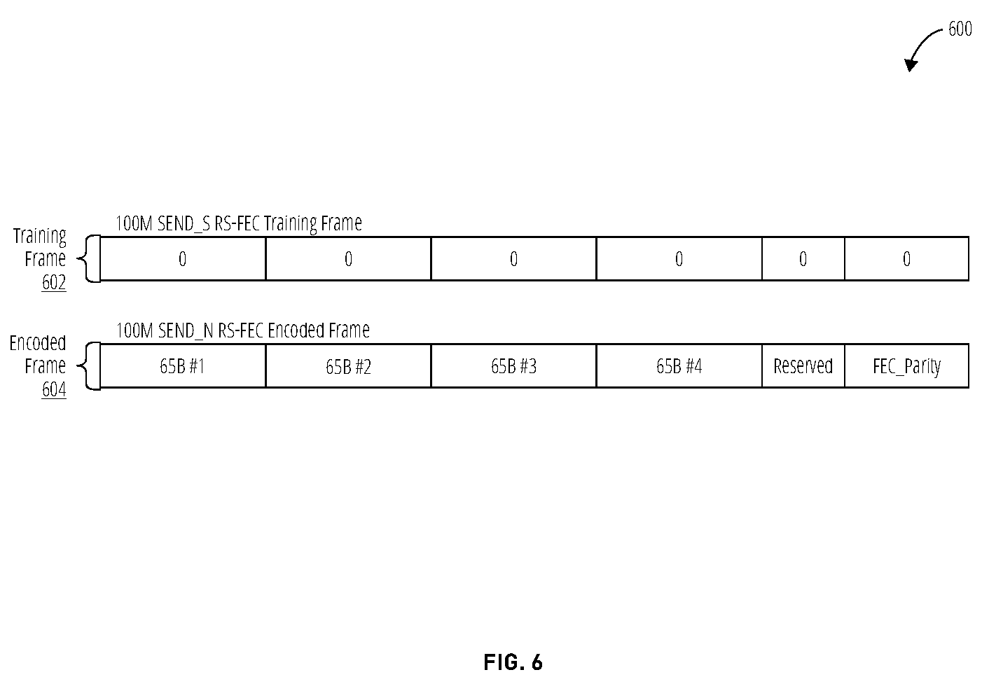

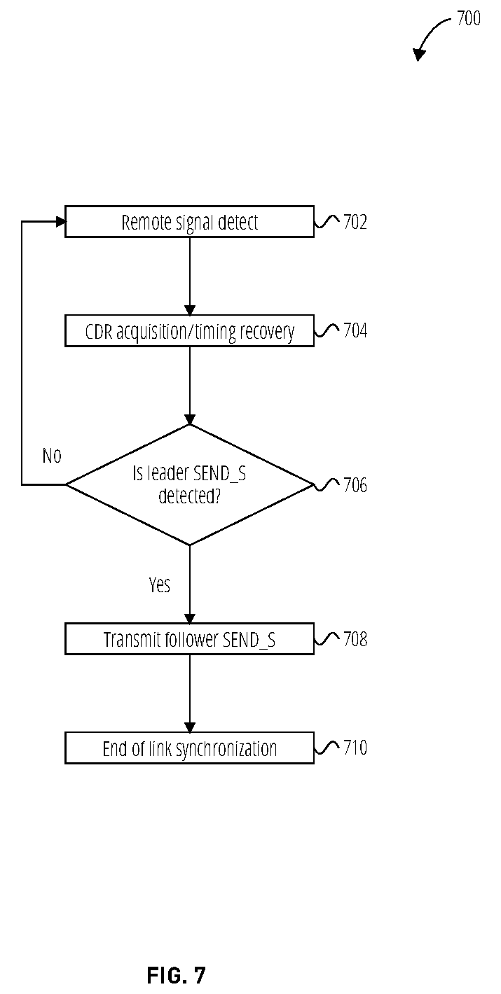

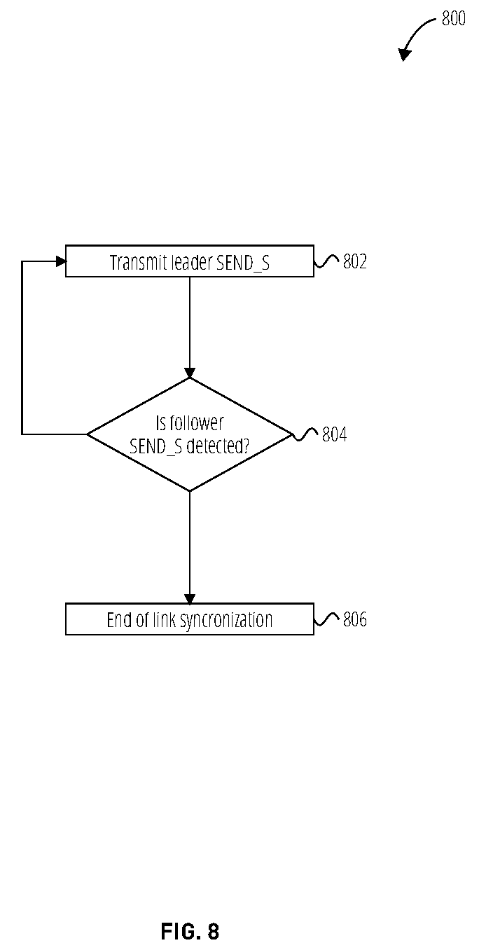

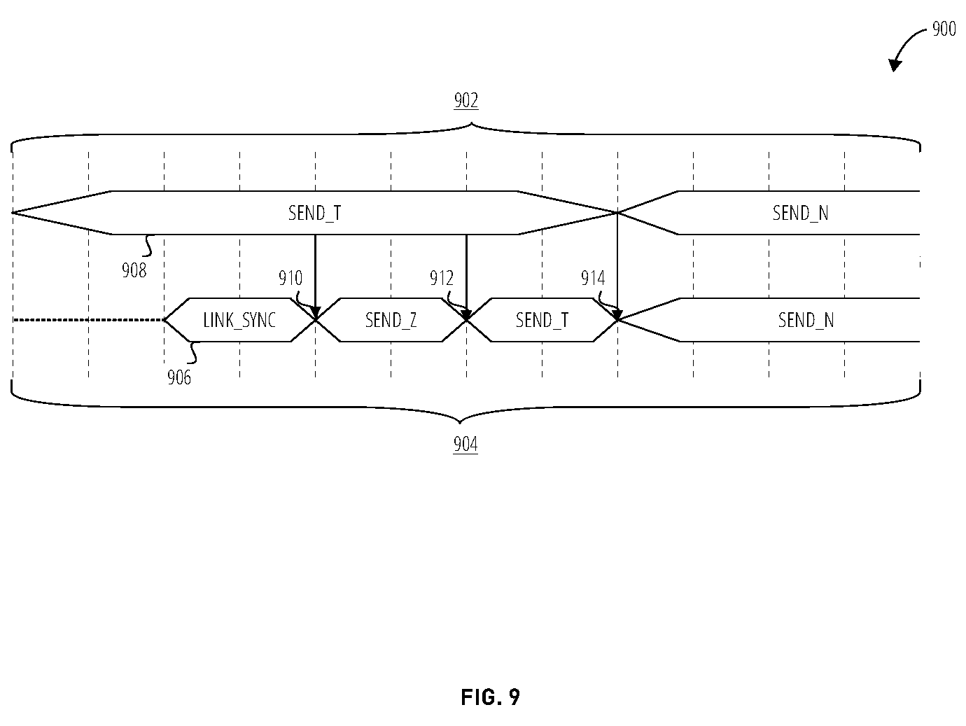

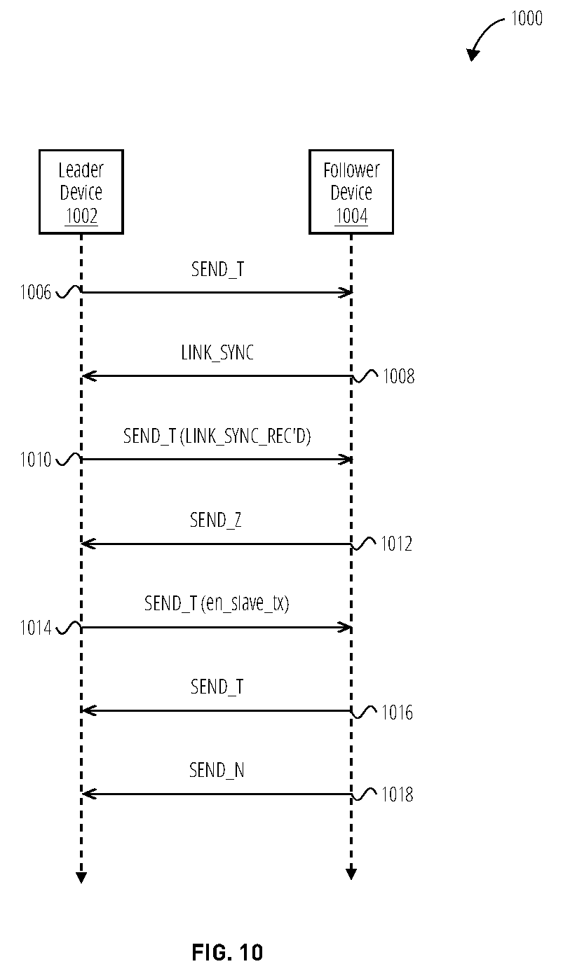

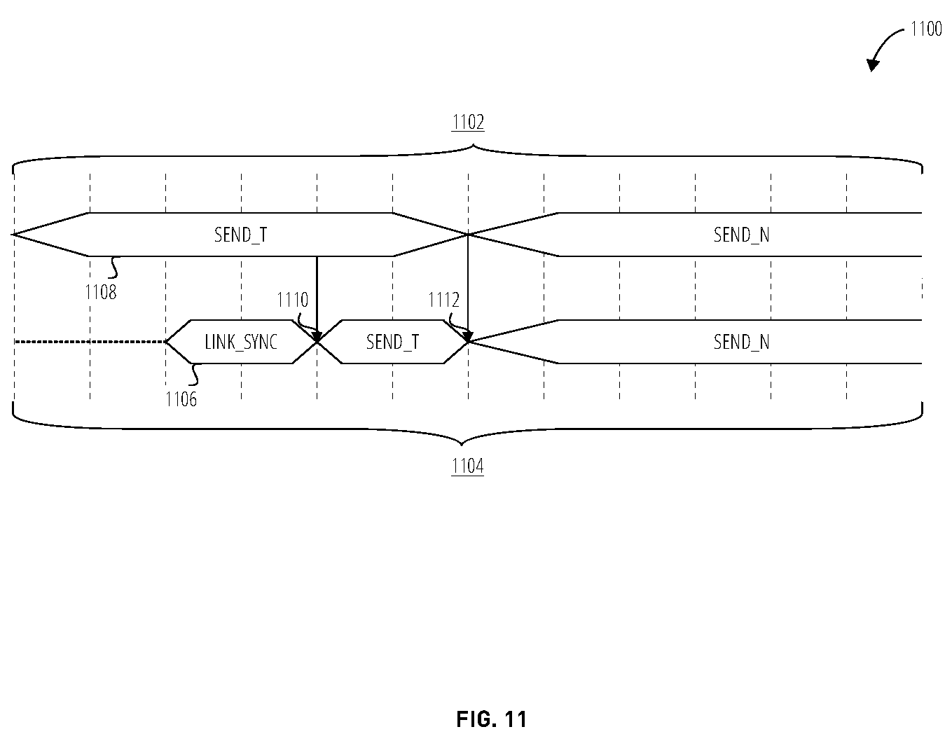

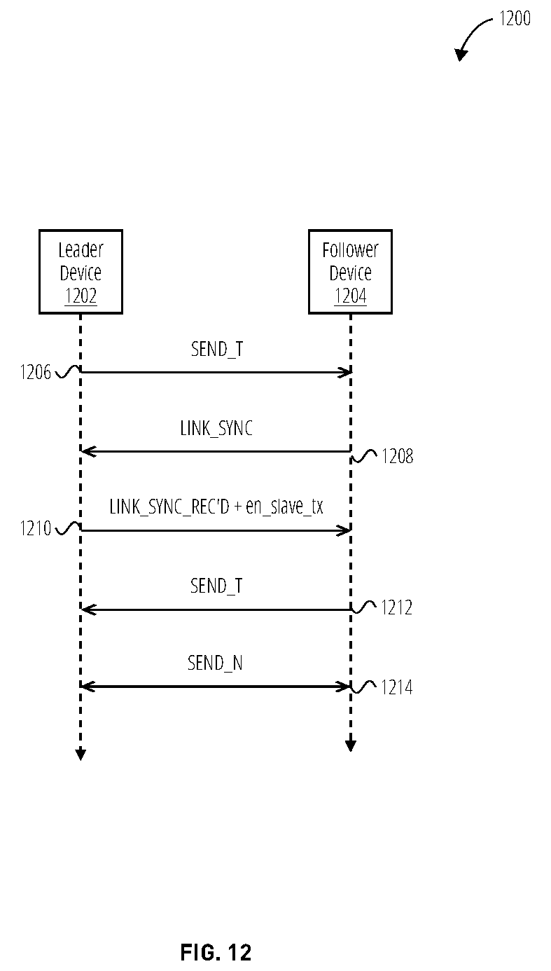

The following description refers to the accompanying drawings, which illustrate exemplary aspects of the present disclosure. FIGS. 1 and 2 illustrate block diagrams of a leader device and a follower device, respectively, configured for link synchronization. FIGS. 3A–3C illustrate flowcharts for methods of link synchronization. FIGS. 4 and 5 illustrate sequence diagrams representing signal exchanges during link synchronization between a leader device and a follower device. FIG. 6 illustrates a frame structure depicting signal framing for link synchronization and training. FIGS. 7 and 8 illustrate flowcharts for link synchronization methods from the perspectives of a follower device and a leader device, respectively. FIGS. 9 and 11 illustrate timing diagrams representing signal exchanges and transitions during link synchronization. FIGS. 10 and 12 illustrate link synchronization diagrams and sequence diagrams showing closed-loop acknowledgment mechanisms.

Referring to FIG. 1, a link synchronization system for crystal-less communication links includes a leader device 100. The leader device 100 includes a transmitter 102 configured to transmit signals to a follower device. The transmitter 102 may transmit a continuous synchronization signal to the follower device. The continuous synchronization signal omits quiet periods between successive synchronization transmissions. In some embodiments, the continuous synchronization signal employs a symbol rate equal to a symbol rate used during data transmission.

With continued reference to FIG. 1, the transmitter 102 includes a data-mode scrambler 104 configured to scramble zeros. Scrambling zeros refers to applying a scrambling algorithm to a sequence of zero-valued input bits to produce a pseudo-random output sequence. Without scrambling, transmitting a continuous stream of zeros would produce a constant signal level with no transitions, from which timing recovery circuitry cannot extract clock information. By scrambling the zeros, the data-mode scrambler 104 transforms the constant zero input into a varying bit pattern that, when encoded and transmitted, produces signal transitions at a rate sufficient for timing recovery circuitry at the receiving device to detect edges and extract clock information for synchronization. The resulting continuous synchronization signal, which may also serve as a training signal, comprises scrambled zeros that produce signal transitions suitable for timing recovery. Accordingly, the continuous synchronization signal comprises a training signal that comprises scrambled zeros. The transmitter 102 may generate the continuous synchronization signal by scrambling zeros using the data-mode scrambler 104 and encoding the scrambled output using differential Manchester encoding.

The leader device 100 further includes a differential encoder 106 configured to receive output from the data-mode scrambler 104. The differential encoder 106 encodes the scrambled signal using differential Manchester encoding. Differential Manchester encoding represents data through signal transitions rather than signal levels. This transition-based representation permits clock extraction, enabling receivers to extract timing information from the transmitted signal.

As further shown in FIG. 1, the leader device 100 includes a receiver 108 configured to receive signals from a transmitter 206 of the follower device. The receiver 108 monitors for a synchronization response from the follower device during a link synchronization phase. The leader device 100 also includes a controller 110 coupled to the transmitter 102 and the receiver 108. The controller 110 manages operation of the leader device 100 during link synchronization by directing the transmitter 102 to transmit the continuous synchronization signal and by monitoring the receiver 108 for a synchronization response from the follower device.

The arrangement of the data-mode scrambler 104 and the differential encoder 106 within the transmitter 102 enables the leader device 100 to generate a continuous synchronization signal that employs the same encoding and symbol rate used during data transmission. This arrangement allows a receiving device to use the same timing recovery circuitry for both synchronization and data modes. Timing recovery circuitry shared by synchronization and data modes may include clock and data recovery circuits, phase-locked loops, phase detectors, loop filters, or digital timing recovery loops. Because the continuous synchronization signal employs a symbol rate equal to a symbol rate used during data transmission, the receiving device may reuse timing recovery circuitry without mode-specific hardware or signal format transitions.

The transmitter 102 of the leader device 100 transmits the continuous synchronization signal to a receiver 202 of the follower device, described in greater detail below with reference to FIG. 2. The differential encoder 106 provides the encoded signal to the receiver 202, which extracts clock information from the continuous synchronization signal despite frequency offsets that may exist between the leader device 100 and the follower device. The transmitter 206 of the follower device transmits signals to the receiver 108 of the leader device 100, enabling bidirectional communication between the devices during link synchronization.

In some embodiments, the continuous synchronization signal may employ encoding schemes other than differential Manchester encoding. For example, the continuous synchronization signal may employ 8B/10B encoding, which provides direct current balance and embedded clock information while maintaining compatibility with existing transceiver architectures. The 8B/10B encoding scheme maps eight-bit data words to ten-bit symbols, ensuring sufficient transitions for clock recovery and maintaining direct current balance regardless of data content.

In some embodiments, the continuous synchronization signal may employ pulse amplitude modulation with three levels (PAM-3) encoding to increase information density of the synchronization signal, enabling faster parameter exchange during link establishment. PAM-3 encoding transmits one of three distinct amplitude levels per symbol period, providing higher information throughput compared to binary encoding schemes while still enabling reliable clock extraction by timing recovery circuitry.

In some embodiments, the continuous synchronization signal may employ pulse amplitude modulation with four levels (PAM-4) encoding. PAM-4 encoding transmits one of four distinct amplitude levels per symbol period, providing higher information throughput compared to PAM-3 and binary encoding schemes. PAM-4 encoding may be employed in configurations where the communication link supports multi-level signaling and where the timing recovery circuitry is configured to extract clock information from four-level amplitude transitions. The use of PAM-4 encoding for the continuous synchronization signal may enable compatibility with high-speed communication standards that employ PAM-4 modulation during data transmission, allowing the same encoding scheme to be used for both synchronization and data modes.

In some embodiments, the system may adaptively select the encoding scheme based on detected frequency offset. The timing recovery circuitry may determine a frequency offset magnitude based on adjustments that the system may apply during clock acquisition. When the detected frequency offset is below a first threshold (e.g., 10 percent), the system may employ PAM-3 encoding to maximize information density and enable faster parameter exchange during link establishment. When the detected frequency offset exceeds the first threshold or approaches a frequency offset tolerance limit (e.g., 20 percent or more), the system may switch to differential Manchester encoding or 8B/10B encoding to provide more robust clock extraction. Operators and/or executing programs may configure the threshold values via register settings, allowing adjustment of the encoding selection criteria based on expected operating conditions and oscillator characteristics. For example, in configurations employing lower-cost oscillators with moderate accuracy, the system may set the first threshold at 10 percent. In configurations employing resistance-capacitance oscillators with wider frequency variations, the system may set the first threshold at a higher value, such as 15 percent, to accommodate the expected frequency offset range.

Regardless of the specific encoding scheme employed, the continuous synchronization signal maintains the characteristic of omitting quiet periods between successive synchronization transmissions. These characteristics allow timing recovery circuitry to extract clock information and derive timing during both synchronization and data transmission phases, which may eliminate the need for dedicated link synchronization detection circuitry.

Referring to FIG. 2, a follower device 200 performs link synchronization in a communication system. The follower device 200 receives signals from a transmitter 102 of the leader device 100 and transmits signals to a receiver 108 of the leader device 100. The follower device 200 includes several interconnected components that enable link synchronization despite frequency offsets between the follower device 200 and the leader device 100.

The follower device 200 includes a receiver 202 configured to receive a continuous synchronization signal from the leader device 100. The continuous synchronization signal omits quiet periods between successive synchronization transmissions. In some embodiments, the continuous synchronization signal employs a symbol rate equal to a symbol rate used during data transmission. The receiver 202 monitors for the continuous synchronization signal transmitted by the transmitter 102 and provides the received signal to downstream components for processing.

With continued reference to FIG. 2, the follower device 200 includes timing recovery circuitry 204 coupled to the receiver 202. The timing recovery circuitry 204 extracts clock information from the continuous synchronization signal and derives timing therefrom to compensate for a frequency offset relative to the leader device 100.

To extract clock information, the timing recovery circuitry 204 may include a phase detector that measures timing errors from symbol transitions in the received signal by comparing the timing of received symbol transitions against an expected timing reference. The phase detector generates a timing error signal indicating whether a local sampling clock leads or lags the received signal transitions. A loop filter coupled to the phase detector integrates the timing error signal over time to produce a frequency correction value, smoothing short-term timing variations while tracking the underlying frequency offset. A numerically controlled oscillator or voltage controlled oscillator receives the frequency correction value from the loop filter and adjusts the sampling clock frequency and phase accordingly, thereby aligning the local sampling clock with the timing of the received continuous synchronization signal.

Because the continuous synchronization signal employs a symbol rate equal to a symbol rate used during data transmission, the timing recovery circuitry 204 may operate during both link synchronization and data reception. The timing recovery circuitry 204 is configured to perform clock extraction during both synchronization and data transmission phases, which may eliminate the requirement for dedicated link synchronization detection circuitry separate from the timing recovery circuitry 204.

The timing recovery circuitry 204 may employ different configuration parameters when operating in a link synchronization mode versus a data mode. For example, during link synchronization, the timing recovery circuitry 204 may be configured with a wider loop bandwidth, such as 50 kHz to 500 kHz, to permit rapid correction of large frequency errors during initial acquisition. During data mode, the timing recovery circuitry 204 may be configured with a narrower loop bandwidth, such as 1 kHz to 10 kHz, optimized for rejection of short-term timing variation and jitter while tracking residual phase drift and slow frequency drift. Damping factor parameters may also be adjusted between modes, with lower damping during synchronization to enable faster frequency acquisition and higher damping during data mode to maintain stability and reduce overshoot. Acquisition thresholds may differ between modes, with the synchronization mode employing thresholds configured for initial lock acquisition across a wide frequency offset range and the data mode employing thresholds configured for maintaining lock under normal operating conditions. The timing recovery circuitry 204 may require initialization or reset when transitioning between synchronization and data modes to ensure proper operation in each phase.

As further shown in FIG. 2, the follower device 200 includes a transmitter 206 configured to transmit a synchronization response to the leader device 100 using timing derived from the extracted clock information. The transmitter 206 transmits the synchronization response to the receiver 108 of the leader device 100, indicating that the follower device 200 has detected the continuous synchronization signal and is ready to proceed with link establishment. The follower device 200 derives operational timing from the continuous synchronization signal transmitted by the leader device 100. In some embodiments, the follower device 200 lacks a local crystal oscillator.

The follower device 200 further includes a detector 208 coupled to the receiver 202. The detector 208 receives signals from the receiver 202 and validates the received synchronization signal. To perform validation, the detector 208 seeds a local pseudo-random binary sequence generator with an initial sequence of symbols captured from the continuous synchronization signal and compares predicted symbols generated by the local pseudo-random binary sequence generator against subsequently received symbols.

With continued reference to FIG. 2, the follower device 200 includes a pseudo-random binary sequence generator 210 coupled to the detector 208. The detector 208 captures an initial sequence of symbols (e.g., seven symbols, eight symbols, fifteen symbols, or other lengths corresponding to the PRBS generator configuration) from the received continuous synchronization signal and uses this captured sequence as a seed value for the pseudo-random binary sequence generator 210. Once seeded, the pseudo-random binary sequence generator 210 produces a predicted symbol sequence. The detector 208 compares the predicted symbol sequence against subsequently received symbols to validate the received synchronization signal. When the comparison indicates a match between predicted and received symbols over a sufficient number of symbol periods, the detector 208 declares successful detection of the continuous synchronization signal. The detector 208 may perform the comparison using symbol-by-symbol comparison, comparing each predicted symbol against the corresponding received symbol to determine whether they match, and may count matching symbols or compute a correlation value to determine when a match threshold is satisfied.

The detector 208 may employ signal validation criteria to confirm the presence of a valid synchronization signal before declaring successful detection and initiating a response. The signal validation criteria may include a requirement for a minimum number of consecutive matching symbols (e.g., 2 symbols, 16 symbols, or 32 symbols), a correlation coefficient threshold (e.g., 0.8, 0.9, 0.95, etc.) computed over a sliding window of symbols, or a signal amplitude threshold that distinguishes a valid synchronization signal from noise or interference.

The follower device 200 also includes a controller 212 coupled to the timing recovery circuitry 204, the detector 208, the pseudo-random binary sequence generator 210, and the transmitter 206. The controller 212 manages overall operation of the follower device 200 and coordinates transitions between link synchronization, training, and data modes. The controller 212 receives inputs from the timing recovery circuitry 204 and the detector 208 to determine when the continuous synchronization signal has been successfully detected and when the follower device 200 should transmit the synchronization response via the transmitter 206.

FIGS. 3A–3C illustrate methods 300, 320, and 330 of link synchronization in a communication system. The methods 300, 320, and 330 enable a first physical layer device to achieve synchronization with a second physical layer device despite frequency offsets between the devices. This capability supports crystal-less configurations where the first physical layer device lacks a local crystal oscillator and derives operational timing from a continuous synchronization signal transmitted by the second physical layer device.

FIG. 3A illustrates method 300, which begins at block 302, where the first physical layer device receives a continuous synchronization signal from the second physical layer device. As described previously, the continuous synchronization signal omits quiet periods between successive synchronization transmissions. The continuous nature of the synchronization signal enables the first physical layer device to extract clock information despite frequency offsets between the devices. The second physical layer device may continue transmitting the continuous synchronization signal indefinitely (or for a reasonable timeout period) when the first physical layer device has not yet powered on or is not yet ready, accommodating scenarios where the first physical layer device powers up later than the second physical layer device. In other embodiments, the second physical layer device may implement timeout mechanisms, retry logic with a configurable number of attempts, transitions to a low-power sleep state between retry attempts, or other power management features during extended waiting periods, as described below with reference to FIGS. 8 and 10.

With continued reference to FIG. 3A, the method 300 proceeds to block 304, where the first physical layer device extracts clock information from the continuous synchronization signal using timing recovery circuitry. The timing recovery circuitry, such as timing recovery circuitry 204 of the follower device 200 shown in FIG. 2, performs clock extraction during both synchronization and data transmission phases. This enables the same circuitry to serve both link synchronization and subsequent data reception without requiring dedicated link synchronization detection circuitry.

The method 300 continues to block 306, where the first physical layer device derives timing from the continuous synchronization signal to compensate for a frequency offset relative to the second physical layer device. The timing recovery circuitry may employ a two-phase acquisition process to derive timing that compensates for the frequency offset. In a first phase, a frequency acquisition process estimates and cancels a gross frequency offset by sweeping or stepping a frequency control over a configurable pull-in range while measuring a timing error metric generated from symbol transitions. A frequency discriminator may accumulate transition timing errors and produce a signed frequency correction to reduce the offset. In a second phase, after the residual frequency error falls within a lock-in range, the circuitry transitions to phase tracking with a narrower loop bandwidth optimized for rejecting short-term timing variation. A phase detector and loop filter track residual phase and slow frequency drift while maintaining symbol timing. The continuous synchronization signal approach enables clock recovery despite frequency offsets between the first physical layer device and the second physical layer device. The method 300 then proceeds to block 308, where the first physical layer device transmits a synchronization response to the second physical layer device using timing derived from the extracted clock information.

The continuous synchronization signal approach may accommodate various frequency offset ranges. In some embodiments, the approach optimizes for frequency offsets up to 10 percent, enabling use of lower-cost oscillators with moderate accuracy. In other embodiments, the approach accommodates higher frequency offsets (e.g., up to 20 percent, 30 percent, 40 percent, or more) by employing wider-bandwidth timing recovery loops and extended acquisition algorithms for operation with extremely low-cost resistance-capacitance oscillators. The frequency offset tolerance may be configurable via register settings to allow the same hardware to operate in both crystal-based and crystal-less configurations with appropriate parameter adjustments.

To achieve clock lock at significant frequency offsets (i.e., ranging from approximately ten percent to forty percent or more), the timing recovery circuitry may employ a two-phase acquisition process with parameterized loop bandwidth and pull-in range. In a first phase, a frequency acquisition process estimates and cancels a gross frequency offset by sweeping or stepping a frequency control over a configurable pull-in range at least as large as the expected frequency offset tolerance. The process measures a timing error metric generated from symbol transitions and integrates that metric over configurable windows to determine a correction. In some cases, a frequency discriminator accumulates transition timing errors and produces a signed frequency correction to reduce the offset. During this first phase, the loop bandwidth may be widened to permit rapid correction of large frequency errors. For example, a controller may select a timing recovery loop bandwidth ranging from fifty thousand hertz to five hundred thousand hertz for extended tolerance configurations, with selectable damping and maximum slew limits to maintain stability.

In a second phase, after the residual frequency error falls within a lock-in range, the circuitry may transition to phase tracking with a narrower loop bandwidth optimized for rejecting short-term timing variation. A phase detector and loop filter may track residual phase and slow frequency drift while maintaining symbol timing. The pull-in range of the frequency acquisition process may be programmably set to no less than the maximum permitted frequency offset. Accordingly, ranges spanning at least plus or minus ten percent, plus or minus twenty percent, plus or minus thirty percent, plus or minus forty percent, or other suitable ranges may be used based on configuration and channel conditions. Parameters such as loop bandwidth, damping factor, frequency step size or sweep rate, integration window length, decision thresholds, and/or handover criteria between phases may be configurable via register settings. This configurability enables the same hardware (e.g., phase-locked loops, phase detectors, loop filters, digital timing recovery loops, and/or other timing recovery components) to acquire and hold lock across the intended frequency offset tolerance.

The method 300 includes block 310, indicated by dashed lines in FIG. 3A, representing an optional step where the first physical layer device receives an acknowledgment indication from the second physical layer device upon successful receipt of the synchronization response. The acknowledgment indication confirms to the first physical layer device that the second physical layer device received the synchronization response. This closed-loop feedback mechanism addresses synchronization failures that could otherwise occur when channel noise corrupts acknowledgments in open-loop approaches. Upon detecting the acknowledgment indication, the controller of the first physical layer device coordinates the transition to a training or data mode based on successful detection validation. The transition may occur within a configurable time window following detection, such as within one to ten symbol periods after the detector confirms receipt of the acknowledgment indication. In some embodiments, the state machine of the first physical layer device may progress through intermediate states (such as a validation state where the controller confirms that the acknowledgment indication satisfies predefined criteria) before entering the training or data mode. In embodiments where the system combines training with synchronization using the unified signal structure described herein, or where training completes during the synchronization phase, the first physical layer device may transition directly to a data reception mode upon detecting the acknowledgment indication.

In some embodiments, the second physical layer device may implement power management considerations during extended waiting periods when the second physical layer device receives no response from the first physical layer device. For example, the transmitter of the second physical layer device may operate in a reduced-power mode during link synchronization compared to data mode, as the receiver detects the synchronization signal rather than recovering high-fidelity data. This reduced-power mode maintains continuous transmission of the synchronization signal without quiet periods.

In some embodiments, power management features are applied compatibly with the continuous synchronization signal approach. For example, the transmitter may operate at reduced output power during link synchronization while maintaining continuous transmission without quiet periods, and the receiver circuitry may monitor in a reduced-power state with full-power acquisition enabled upon initial detection. In other embodiments, the transmitter may employ a burst-mode arrangement in which transmission is sustained for a detection window period followed, in some cases, by a brief intermission. The detection window is a duration sufficient for the receiver to acquire and maintain clock lock and detect the synchronization signal, such as milliseconds to tens of milliseconds. Any intermission is selected so that timing recovery remains held or quickly reacquires without loss of effective continuity at the receiver. The detection window duration may be configurable or selected based on system requirements. These power management embodiments may be implemented while retaining the continuous synchronization signaling characteristics from the receiver’s perspective, enabling energy savings without negating the benefits of uninterrupted clock acquisition and retention across expected frequency offsets. Accordingly, some embodiments maintain continuous transmission without quiet periods, and other embodiments apply the foregoing power management techniques as appropriate to meet system-level power objectives while supporting reliable synchronization.

FIG. 3B illustrates method 320, which includes blocks 302, 304, 306, and 308 as described above with reference to FIG. 3A. The method 320 further includes block 322, indicated by dashed lines in FIG. 3B, representing an optional step where the first physical layer device transmits a training signal to the second physical layer device. The training signal enables the second physical layer device to complete physical medium attachment layer training, including clock and data recovery acquisition, timing recovery, equalizer training, and echo cancellation. In configurations where the first physical layer device receives data at a first data rate and transmits data at a second data rate higher than the first data rate, the training signal transmitted by the first physical layer device provides the second physical layer device with a signal from which the second physical layer device can complete training operations. The first physical layer device may continue transmitting the training signal for a duration sufficient to enable the second physical layer device to complete physical medium attachment layer training, regardless of the specific training signal designation employed.

FIG. 3C illustrates method 330, which includes blocks 302, 304, 306, and 308 as described above with reference to FIG. 3A. The method 330 further includes blocks 332 and 334, indicated by dashed lines in FIG. 3C, representing optional steps for validating the continuous synchronization signal. At block 332, the first physical layer device seeds a local pseudo-random binary sequence generator with an initial sequence of symbols captured from the continuous synchronization signal. The first physical layer device captures an initial sequence of symbols from the received continuous synchronization signal and uses this captured sequence as a seed value for the local pseudo-random binary sequence generator. At block 334, the first physical layer device compares predicted symbols generated by the local pseudo-random binary sequence generator against subsequently received symbols to validate the continuous synchronization signal. Once seeded, the local pseudo-random binary sequence generator produces a predicted symbol sequence. The first physical layer device compares the predicted symbol sequence against subsequently received symbols to validate the received synchronization signal. When the comparison indicates a match between predicted and received symbols over a sufficient number of symbol periods, the first physical layer device declares successful detection of the continuous synchronization signal. This validation process provides enhanced immunity to noise and interference by confirming that the detected signal is a valid continuous synchronization signal from the second physical layer device rather than noise or interference.

FIG. 4 illustrates a sequence diagram 400 depicting a link synchronization process between the leader device 100 and the follower device 200. The sequence diagram 400 shows the signal exchange during the synchronization phase as the leader device 100 and the follower device 200 establish a communication link.

The leader device 100 transmits a continuous synchronization signal 402 to the follower device 200. The continuous synchronization signal 402 comprises multiple successive transmissions, including a SEND_S transmission 404a, a SEND_S transmission 404b, and a SEND_S transmission 404c, sent consecutively without intervening quiet periods. By maintaining this continuous transmission, the leader device 100 enables the follower device 200 to extract clock information despite any frequency offsets between the two devices.

With continued reference to FIG. 4, upon detecting the continuous synchronization signal 402, the follower device 200 transmits a synchronization response 406 to the leader device 100. The sequence diagram 400 labels this synchronization response 406 as LINK_SYNC, indicating that the follower device 200 has detected the leader device 100 and is ready to proceed with link establishment. The transmitter 206 of the follower device 200 sends the synchronization response 406 to the receiver 108 of the leader device 100 using timing derived from the extracted clock information.

In some embodiments, the system may generate the continuous synchronization signal 402 using pseudo-random binary sequences of varying lengths beyond an 8-bit configuration. For example, the system may employ a 7-bit pseudo-random binary sequence using a suitable polynomial (e.g., the polynomial x7+x6+1) that provides a shorter sequence with reduced implementation complexity. Alternatively, the system may employ a 15-bit pseudo-random binary sequence using a different suitable polynomial (e.g., x15 + x14 + 1 that provides a longer sequence with improved autocorrelation properties for enhanced detection reliability in high-noise environments. The system may select the pseudo-random binary sequence length based on expected channel conditions, favoring shorter sequences for low-latency applications and longer sequences for improved noise immunity.

The transmission rate of the continuous synchronization signal 402 may also vary based on system requirements and power considerations. The leader device 100 may transmit the continuous synchronization signal 402 at baud rates other than the data-mode baud rate. In some embodiments, the continuous synchronization signal 402 employs the data-mode baud rate, such as 117 megahertz, to enable reuse of timing recovery circuitry across synchronization and data modes. In other embodiments, the leader device 100 may transmit the continuous synchronization signal 402 at a submultiple of the data-mode baud rate, such as 58.5 megahertz or 29.25 megahertz, to reduce power consumption during link synchronization while maintaining compatibility with the timing recovery circuitry 204. In further embodiments, the leader device 100 may transmit the continuous synchronization signal 402 at a higher baud rate, such as 234 megahertz, to accelerate clock acquisition in systems prioritizing rapid link establishment. Operators and/or executing programs may adjust register settings to configure the baud rate selection, or the system may determine the baud rate automatically based on channel conditions detected during an initial probing phase.

In some embodiments, the synchronization response 406 transmitted by the follower device 200 may comprise an 8-bit pseudo-random binary sequence transmitted at 703.125 megahertz with no quiet time. The system may select the 703.125 megahertz transmission rate to maintain a defined relationship with the high data rate path, facilitating clock recovery and timing alignment between the asymmetric low data rate and high data rate paths. The 703.125 megahertz rate may be an integer submultiple of the multi-gigabit high data rate baud rate, enabling simplified clock domain crossing and timing derivation between the low data rate and high data rate paths. This transmission rate may enable the receiver 108 of the leader device 100 to detect the follower device 200 and extract clock information for synchronization.

Referring to FIG. 5, a sequence diagram 500 illustrates the interaction between two physical layer devices during link synchronization. The sequence diagram 500 depicts the temporal relationship of signals that each device transmits during the synchronization process, showing how the devices coordinate their startup and transition to subsequent operational phases.

The sequence diagram 500 includes a leader signal timeline 502 and a follower signal timeline 504. The leader signal timeline 502 represents signals that a leader device transmits, while the follower signal timeline 504 represents signals that a follower device transmits. The sequence diagram 500 positions the leader signal timeline 502 at the top and the follower signal timeline 504 at the bottom to illustrate the temporal coordination between the two devices.

With continued reference to FIG. 5, the process begins when the leader device transmits a SEND_S signal 508 to the follower device. The sequence diagram 500 shows the SEND_S signal 508 originating from the leader device and proceeding in time along the leader signal timeline 502 toward the follower device. As described previously, the SEND_S signal 508 comprises a continuous synchronization signal that omits quiet periods between successive synchronization transmissions, enabling the follower device to extract clock information despite frequency offsets between the two devices. The data-mode scrambler 104 scrambles zeros to produce the SEND_S signal 508, and the differential encoder 106 encodes the scrambled signal using differential Manchester encoding.

Upon detecting the SEND_S signal 508, the follower device responds by transmitting a LINK_SYNC message 506 to the leader device. The sequence diagram 500 shows the LINK_SYNC message 506 originating from the follower device and extending along the follower signal timeline 504. The LINK_SYNC message 506 serves as a synchronization response indicating that the follower device has detected the leader device and is ready to proceed with link establishment. The transmitter 206 of the follower device 200 transmits the LINK_SYNC message 506 to the receiver 108 of the leader device 100 using timing derived from the extracted clock information.

As further shown in FIG. 5, the receiver 108 of the leader device 100 receives the synchronization response from the follower device 200. Although not shown in FIG. 5, in some embodiments, upon receiving the synchronization response, the controller 110 of the leader device 100 may cause the leader device 100 to transmit an acknowledgment indication to the follower device 200. The acknowledgment indication may confirm to the follower device 200 that the leader device 100 received the synchronization response, providing closed-loop feedback during link synchronization.

The leader device 100 may convey the optional acknowledgment indication through various signaling mechanisms. In some embodiments, the leader device 100 conveys the acknowledgment indication by transmitting a specific symbol sequence or preamble pattern rather than modifying a single bit in an information field. In other embodiments, the acknowledgment indication employs a multi-bit field that encodes additional status information such as received signal quality metrics or detected frequency offset magnitude. In some embodiments, the acknowledgment may be implicit: the leader device 100 may transition to a different signal pattern, such as from a training signal to a normal data signal, upon receiving the synchronization response from the follower device 200, and the follower device 200 may detect this transition as confirmation of acknowledgment.

The multi-gigabit transmitter of the follower device may transmit the LINK_SYNC message 506 in a link synchronization signal format defined in communication standards for physical layer devices, enabling compatibility with existing receiver implementations. This conformance to standard signal formats allows the receiver 108 of the leader device 100 to detect and process the LINK_SYNC message 506 using existing detection mechanisms. The continuous synchronization signal disclosed herein enables the follower device to detect and respond despite substantial frequency offsets, such as 10 percent or more in crystal-less configurations and up to 20 percent or more in some implementations. Additionally, the closed-loop acknowledgment mechanism, when employed, enables the leader device to confirm receipt of the synchronization response to the follower device.

Following the exchange of the SEND_S signal 508 and the LINK_SYNC message 506, both the leader signal timeline 502 and the follower signal timeline 504 show a transition to a training phase. Both timelines indicate the training phase in the sequence diagram 500, representing the period during which both devices adjust their receivers to properly interpret incoming signals before data transmission begins. During the training phase, the devices perform clock and data recovery acquisition, timing recovery, equalizer training, and echo cancellation to prepare for reliable data transmission.

FIG. 6 illustrates a frame structure 600 for link synchronization and training operations. The frame structure 600 shows the relationship between signal framing used during link synchronization and signal framing used during data transmission. This relationship enables consistent signal characteristics across synchronization, training, and data modes.

The frame structure 600 includes a training frame 602 labeled 100M SEND_S RS-FEC Training Frame. This designation indicates a training frame transmitted at 100 megabits per second using the SEND_S signal format with Reed-Solomon forward error correction encoding. The training frame 602 comprises a sequence of zeros across multiple fields, providing a known reference pattern for receiver calibration. Although FIG. 6 depicts the training frame 602 as containing zeros, the data-mode scrambler described above may scramble these zeros before transmission to produce a continuous synchronization signal with transitions suitable for timing recovery, as also described above. The continuous synchronization signal thus comprises a training signal that comprises scrambled zeros, enabling the signal to serve both synchronization and training functions. The training frame 602 serves both synchronization and training functions due to this unified signal structure. This enables the first physical layer device to transition from link synchronization to training without a quiet period between synchronization and training phases.

With continued reference to FIG. 6, the frame structure 600 includes an encoded frame 604 labeled 100M SEND_N RS-FEC Encoded Frame. This designation indicates an encoded data frame transmitted at 100 megabits per second using the SEND_N signal format with Reed-Solomon forward error correction encoding. The encoded frame 604 incorporates a block structure comprising four 65-bit blocks labeled 65B #1, 65B #2, 65B #3, and 65B #4. The encoded frame 604 further includes a reserved field and a forward error correction parity field. The forward error correction parity field enables the receiver to detect and correct transmission errors that may occur during data transmission over the communication link.

The frame structure 600 arranges the training frame 602 and the encoded frame 604 to illustrate a unified frame structure that maintains consistent signal characteristics whether the system operates in synchronization mode, training mode, or data transmission mode. By employing the same symbol rate and encoding across all modes, the unified frame structure permits the system to reuse timing recovery circuitry without requiring mode-specific hardware or signal format transitions.

In some embodiments, the training frame 602 may include periodic marker symbols or sync words that enable the receiver to identify frame boundaries without requiring a separate transition indication. These marker symbols provide reference points within the training frame 602 that allow the timing recovery circuitry to determine frame alignment during the synchronization and training phases.

In some embodiments, the training frame 602 may include an embedded header field that carries configuration parameters such as intended data rate or equalizer settings. The embedded header field enables faster link establishment by eliminating a separate parameter negotiation phase. The training frame 602 conveys these configuration parameters during the combined synchronization and training phase.

In some embodiments, the signal framing of the frame structure 600 may include redundant synchronization information distributed throughout the frame to enable recovery from burst errors during the synchronization phase. This redundant synchronization information provides multiple opportunities for the receiver to acquire synchronization even when noise or interference corrupts portions of the received signal. This approach improves reliability of the link synchronization process in challenging channel conditions.

FIG. 7 illustrates a flowchart 700 for link synchronization from the perspective of a follower device. Flowchart 700 depicts the sequence of operations that a follower device performs to achieve link synchronization with a leader device using a continuous synchronization signal. This process enables clock recovery despite frequency offsets that may exist in crystal-less configurations, where the follower device lacks a local crystal oscillator and derives operational timing from the continuous synchronization signal.

The flowchart 700 begins at a block 702, where the follower device performs remote signal detection to identify the presence of a continuous synchronization signal from a leader device. During remote signal detection, the receiver 202 of the follower device 200 monitors for incoming signals from the transmitter 102 of the leader device 100. The remote signal detection operation identifies whether the communication link carries a signal and provides an initial indication that the leader device is transmitting.

With continued reference to FIG. 7, the flowchart 700 proceeds to a block 704, where the follower device performs clock and data recovery acquisition and timing recovery. During this step, the timing recovery circuitry 204 of the follower device 200 extracts clock information from the continuous synchronization signal and derives timing to compensate for a frequency offset relative to the leader device 100. As described previously, the continuous synchronization signal employs encoding, such as scrambled zeros with differential Manchester encoding, that produces signal transitions. The timing recovery circuitry 204 uses these transitions to continuously track and correct frequency errors. This continuous tracking permits the timing recovery circuitry 204 to extract clock information and derive timing at frequency offsets of approximately 10 percent or more. This threshold exceeds the offset at which intermittent synchronization signals separated by quiet periods fail to achieve clock lock, because the quiet periods interrupt the continuous frequency tracking used for large offset acquisition. In crystal-less configurations, the frequency offset may be at least 10 percent. The timing recovery circuitry 204 performs clock extraction during both synchronization and data transmission phases, enabling the same circuitry to handle both link synchronization and subsequent data reception.

The flowchart 700 then moves to a decision block 706, where the follower device determines whether it detects a leader SEND_S signal. The detector 208 of the follower device 200 validates the received signal to confirm that the continuous synchronization signal from the leader device 100 is present and valid. If the follower device does not detect the leader SEND_S signal, as indicated by the negative branch from the decision block 706, the flowchart 700 returns to the block 702 to continue monitoring for the remote signal. This loop continues until the follower device successfully detects the leader SEND_S signal.

If the follower device detects the leader SEND_S signal, as indicated by the affirmative branch from the decision block 706, the flowchart 700 proceeds to a block 708. At the block 708, the follower device transmits a follower SEND_S signal as a synchronization response to the leader device. The transmitter 206 of the follower device 200 transmits the follower SEND_S signal to the receiver 108 of the leader device 100 using timing derived from the extracted clock information. The follower SEND_S signal indicates to the leader device 100 that the follower device 200 has detected the continuous synchronization signal and is ready to proceed with link establishment.

Following transmission of the follower SEND_S signal, the flowchart 700 proceeds to a block 710, which represents the end of link synchronization. At the block 710, the follower device 200 has completed the link synchronization phase and may transition to training or data modes. The controller 212 of the follower device 200 coordinates this transition from link synchronization to subsequent operational phases based on successful completion of the synchronization process.

In some embodiments, the detector 208 may require correlation of a minimum number of consecutive symbols (e.g., at least 2 symbols, at least 4 symbols, at least 16 symbols, etc.) before declaring successful detection. This correlation requirement for detection validation may provide enhanced immunity to burst noise at the cost of increased detection latency. This correlation requirement is distinct from the 8-symbol initial sequence used to seed the pseudo-random binary sequence generator 210 as described previously. The seeding operation captures symbols to initialize the generator, while the correlation requirement validates that predicted symbols match received symbols over a sufficient window to confirm detection. The threshold selection balances detection speed against false detection probability. Higher thresholds may provide enhanced immunity to noise but may increase detection latency, while lower thresholds may enable faster detection but may increase susceptibility to false detection. The system may select the threshold based on expected channel conditions, such as signal-to-noise ratio or noise characteristics. In general, higher thresholds may be applied in high-noise environments, and lower thresholds may be applied in low-noise environments where rapid link establishment is prioritized.

In some embodiments, the detector 208 may implement a two-stage detection process. In this process, a coarse detection phase triggers a more rigorous fine detection phase before transitioning the state machine. The coarse detection phase rapidly identifies a potential synchronization signal, while the fine detection phase performs more thorough validation. This validation confirms that the detected signal is a valid continuous synchronization signal from the leader device 100 rather than noise or interference.

FIG. 8 illustrates a flowchart 800 for link synchronization from the perspective of a leader device. The flowchart 800 depicts the sequence of operations that a leader device performs to achieve link synchronization with a follower device using a continuous synchronization signal. This approach enables the leader device to coordinate startup with the follower device even when the follower device may not be powered on or ready when the leader device begins transmission.

The flowchart 800 begins at a block 802, where the leader device transmits a leader SEND_S signal as a continuous synchronization signal. The leader SEND_S signal omits quiet periods between successive transmissions, enabling a follower device to extract clock information despite frequency offsets between the leader device and the follower device. As described previously, the transmitter 102 of the leader device 100 generates the continuous synchronization signal by scrambling zeros using the data-mode scrambler 104 and encoding the scrambled output using the differential encoder 106 with differential Manchester encoding. The transmitter 102 transmits the continuous synchronization signal at a first symbol rate, such as a symbol rate corresponding to a low data rate path that carries control information.

With continued reference to FIG. 8, the flowchart 800 proceeds to a decision block 804, where the leader device determines whether it detects a follower SEND_S signal. The receiver 108 of the leader device 100 monitors for a synchronization response from the follower device 200. The receiver 108 receives the synchronization response at a second symbol rate higher than the first symbol rate, such as a symbol rate corresponding to a high data rate path that carries video data. This asymmetric configuration enables the leader device to transmit control information at a lower rate while receiving high-bandwidth data from the follower device 200.

In some embodiments, the leader device implements a timeout mechanism if the leader device does not receive the follower SEND_S signal within an expected time window. The timeout duration for receiving the synchronization response from the follower device may be a fixed value, such as a value in the range of 10 milliseconds to 500 milliseconds, selected based on expected power-up sequencing of the devices. In other embodiments, the timeout duration is adaptive, starting with a short initial timeout and progressively increasing with each retry attempt using an exponential backoff algorithm. This adaptive approach allows the leader device to respond quickly when the follower device is ready while accommodating longer startup times when the follower device requires additional time to power up.

The number of retry attempts may be configurable, such as from 1 to 16 or more retries. In some examples, one or more components of the system transition to a low-power sleep state between retry attempts to conserve energy during extended synchronization failures. This configurable retry mechanism enables the leader device to balance responsiveness against power consumption based on system requirements and expected operating conditions.

After exhausting the configured number of retry attempts, the system may declare a synchronization failure. Upon declaring a synchronization failure, the system may take appropriate action, such as resetting the link synchronization state machine to an initial state, transitioning to an error state that prevents further transmission until a system reset or manual intervention occurs, or signaling an error condition to higher-level system management for logging, alerting, or automated recovery procedures.

The system may include system-level coordination or sequencing requirements between the low data rate and high data rate sides during power-up. Such coordination ensures that both sides of the communication link are prepared for synchronization and that the leader device begins transmitting the continuous synchronization signal at an appropriate time relative to the power-up sequence of the follower device 200.

As further shown in FIG. 8, once the leader device detects the follower SEND_S signal at the decision block 804, indicated by the affirmative branch, the flowchart 800 proceeds to a block 806, which represents the end of link synchronization. At the block 806, the leader device has confirmed the presence of the follower device 200, and both devices are synchronized. This state enables transition to subsequent phases such as training or data transmission. The controller 110 of the leader device 100 coordinates the transition from link synchronization to subsequent operational phases based on successful detection of the follower SEND_S signal.

Referring to FIG. 9, a timing diagram 900 represents signal exchanges during link synchronization between two physical layer devices. The timing diagram 900 depicts the temporal relationship of signals that each device transmits during the synchronization process. The timing diagram 900 illustrates how the devices coordinate their startup and transition to subsequent operational phases, such as training and data transmission.

The timing diagram 900 includes a leader signal timeline 902 and a follower signal timeline 904. The leader signal timeline 902 represents signals that a leader device transmits during the link synchronization process. The follower signal timeline 904 represents signals that a follower device transmits during the link synchronization process. FIG. 9 arranges these timelines to visualize how the leader device and the follower device coordinate their signal exchanges during link synchronization.

With continued reference to FIG. 9, the leader device transmits a continuous synchronization signal 908 to the follower device. The timing diagram 900 labels the continuous synchronization signal 908 as SEND_T, indicating that the continuous synchronization signal 908 comprises a training signal that serves both synchronization and training functions. As described previously, the continuous synchronization signal 908 omits quiet periods between successive synchronization transmissions. The continuous nature of the continuous synchronization signal 908 enables the follower device to extract clock information despite frequency offsets between the leader device and the follower device. In configurations where the first physical layer device (corresponding to the follower device) receives data at a first data rate and transmits data at a second data rate higher than the first data rate, and the second physical layer device (corresponding to the leader device) transmits data at the first data rate and receives data at the second data rate, the continuous synchronization signal 908 enables clock recovery at the follower device despite asymmetric data rate configurations.

Upon detecting the continuous synchronization signal 908, the follower device transmits a synchronization response 906 to the leader device. The timing diagram 900 labels the synchronization response 906 as LINK_SYNC, indicating that the follower device has detected the presence of the leader device and is ready to proceed with link establishment. The follower device transmits the synchronization response 906 using timing that the timing recovery circuitry derives from clock information extracted from the continuous synchronization signal 908. The frequency offset between the leader device and the follower device may be at least 10 percent in crystal-less configurations. The continuous synchronization signal 908 enables the timing recovery circuitry to extract clock information and derive timing despite such frequency offsets.

As further shown in FIG. 9, the timing diagram 900 depicts several transitions that occur during the synchronization process. A transition 910 on the leader signal timeline 902 indicates a temporal alignment point corresponding to where the follower device transitions from transmitting the synchronization response 906 to transmitting SEND_Z on the follower signal timeline 904. The transition 910 represents the point at which the leader device receives the synchronization response 906.

A transition 912 on the follower signal timeline 904 indicates a temporal alignment point corresponding to where the follower device transitions from SEND_Z to SEND_T on the follower signal timeline 904. The SEND_Z period represents a quiet interval during which the follower device transmits a signal with reduced or no transitions, allowing the leader device to confirm receipt of the synchronization response and prepare for subsequent phases of link establishment. The duration of the SEND_Z period may be configurable, such as a number of symbol periods in a range from 8 symbol periods to 64 symbol periods. The duration may be adjusted via register settings based on system timing requirements and coordination needs between the leader device and the follower device. The SEND_Z period provides a coordination function by establishing a defined interval during which the leader device processes the received synchronization response and the follower device awaits confirmation before proceeding to the training phase. In some embodiments employing the unified signal structure described herein, the SEND_Z period may be eliminated entirely. In such embodiments, the follower device transitions directly from transmitting the synchronization response to transmitting a training signal, thereby reducing link establishment latency by omitting the quiet interval between synchronization and training phases.

With continued reference to FIG. 9, following the transitions 910, 912, and 914, both the leader signal timeline 902 and the follower signal timeline 904 show continued transmission of SEND_N signals. The SEND_N signals indicate that both devices have completed link synchronization and transitioned to subsequent phases of link establishment. The SEND_N signals represent normal data frame transmission following completion of the synchronization and training phases.

In configurations where the first data rate is approximately 100 megabits per second for a low data rate path carrying control information, and the second data rate is a multi-gigabit rate for a high data rate path carrying high-bandwidth data, the timing diagram 900 illustrates how the asymmetric communication link achieves synchronization. The leader device transmits the continuous synchronization signal 908 on the low data rate path. The follower device transmits the synchronization response 906 on the high data rate path. This asymmetric configuration enables the leader device to transmit control information at a lower rate while receiving high-bandwidth data from the follower device.

In some embodiments, the follower device transmits a training-complete indication to the leader device via a dedicated bit in an information field. The training-complete indication enables the leader device to adjust a training signal or duration accordingly. The training-complete indication provides feedback to the leader device regarding the training status of the follower device, enabling coordination of the training process between the two devices.

In some embodiments, the follower device continues transmitting the training signal for a fixed duration after completing training, ensuring the leader device has sufficient time to complete training regardless of asymmetric completion times. This fixed duration transmission accommodates scenarios where the leader device requires additional time to complete training operations. Such training operations may include equalizer training, echo cancellation, and/or other training operations.

In some embodiments, the leader device and the follower device exchange training status information bidirectionally, enabling dynamic adjustment of the training process based on the progress of both sides. The bidirectional exchange of training status information allows each device to adapt training parameters or duration based on the training progress of the remote device. This bidirectional exchange improves coordination during the training phase and reduces overall link establishment time.

Referring to FIG. 10, a link synchronization diagram 1000 illustrates a sequence of interactions between a leader device 1002 (which may be an implementation or example of leader device 100) and a follower device 1004 (which may be an implementation or example of follower device 200) during a link synchronization process. The link synchronization diagram 1000 depicts the exchange of signals and messages that establish synchronization between the leader device 1002 and the follower device 1004. The link synchronization diagram 1000 further depicts a closed-loop acknowledgment mechanism that confirms successful receipt of synchronization responses.

The link synchronization process begins at a step 1006, where the leader device 1002 transmits a training signal to the follower device 1004. The training signal transmitted at the step 1006 comprises a continuous synchronization signal that omits quiet periods between successive synchronization transmissions and employs a symbol rate equal to the symbol rate used during data transmission. As described previously, the training signal enables the follower device 1004 to extract clock information and derive timing to compensate for a frequency offset relative to the leader device 1002. The training signal at the step 1006 initiates the synchronization process by providing the follower device 1004 with a continuous signal from which timing recovery circuitry can acquire clock lock.

With continued reference to FIG. 10, at a step 1008, the follower device 1004 transmits a link synchronization signal to the leader device 1002. The link synchronization signal transmitted at the step 1008 indicates that the follower device 1004 has detected the training signal from the leader device 1002 and is ready to proceed with link establishment. The follower device 1004 transmits the link synchronization signal using timing derived from clock information that the follower device 1004 extracted from the training signal received at the step 1006.

At a step 1010, the leader device 1002 transmits an acknowledgment indication to the follower device 1004. The acknowledgment indication transmitted at the step 1010 confirms to the follower device 1004 that the leader device 1002 successfully received the link synchronization signal from the step 1008. The acknowledgment indication comprises a transition of a designated bit within a message field of a 12-octet information field, from a first state to a second state. The leader device 1002 asserts this bit transition upon successful decoding of the link synchronization signal. The leader device 1002 sets this bit in the first information field that the leader device 1002 transmits after receipt of the synchronization response. The designated bit may comprise a newly defined acknowledgment bit that is distinct from the enable slave transmit bit. Alternatively, implementations may repurpose a reserved bit position for this acknowledgment function. The bit transition in the information field provides closed-loop feedback to the follower device 1004, addressing synchronization failures that could otherwise occur when channel noise corrupts acknowledgments in open-loop approaches. Upon detecting the acknowledgment indication, the follower device 1004 proceeds with subsequent phases of link establishment. The link synchronization diagram 1000 labels the step 1010 as including a link synchronization received indication, confirming that the leader device 1002 has received the link synchronization signal from the follower device 1004. The leader device 1002 transmits the acknowledgment indication upon successful receipt of the link synchronization signal, thereby clarifying the temporal relationship between receipt and transmission of the acknowledgment.

As further shown in FIG. 10, at a step 1012, the follower device 1004 transmits a SEND_Z signal to the leader device 1002. The SEND_Z signal transmitted at the step 1012 comprises a quiet interval during which the follower device 1004 transmits no data or transmits a signal with reduced or no transitions. The duration of the SEND_Z signal is configurable, and may comprise a number of symbol periods in a range from 8 symbol periods to 64 symbol periods. Implementations may adjust this duration via register settings based on system timing requirements. The SEND_Z signal serves a coordination function by establishing a defined interval during which the leader device 1002 processes the received synchronization response and prepares for subsequent phases while the follower device 1004 awaits confirmation before proceeding to the training phase.

At a step 1014, the leader device 1002 transmits an enable slave transmit indication (SEND_T (en_slave_tx)) to the follower device 1004. The enable slave transmit indication transmitted at the step 1014 signals to the follower device 1004 that the leader device 1002 is ready for the follower device 1004 to begin transmitting. Depending on the implementation, the enable slave transmit indication at the step 1014 may be transmitted together with the acknowledgment indication, as described with reference to step 1210 in FIG. 12, or may be transmitted separately from the acknowledgment indication. The acknowledgment indication confirms successful receipt of the link synchronization signal and provides the closed-loop feedback that addresses synchronization failures, whereas the enable slave transmit indication indicates transmission readiness. The leader device 1002 combines the enable slave transmit indication at the step 1014 with the training signal, enabling the follower device 1004 to proceed with transmission while the leader device 1002 continues to provide a timing reference through the training signal.

With continued reference to FIG. 10, at a step 1016, the follower device 1004 transmits a follower training signal to the leader device 1002. The follower training signal transmitted at the step 1016 enables the leader device 1002 to perform training operations including clock and data recovery acquisition, timing recovery, equalizer training, and echo cancellation. The follower training signal at the step 1016 provides the leader device 1002 with a signal from which the leader device 1002 can complete physical medium attachment layer training. In configurations where the follower device 1004 completes training before the leader device 1002, the follower device 1004 may transition to a data-receiving state while continuing to transmit the follower training signal to enable the leader device 1002 to complete training. This asymmetric training completion arrangement can reduce overall system startup time by allowing the follower device 1004 to begin receiving data needed for initialization while the leader device 1002 continues training operations. In some embodiments, the follower device 1004 may transmit the follower training signal for a maximum training duration, which may be configurable via register settings based on system requirements and expected training completion times. If the leader device 1002 does not complete training within the maximum training duration, the system may declare a training failure. Upon declaring a training failure, the system may reset the link synchronization state machine to an initial state, transition to an error state that prevents further data transmission until a system reset or manual intervention occurs, or signal an error condition to higher-level system management for logging, alerting, or automated recovery procedures. The follower device 1004 continues transmitting the follower training signal for a duration sufficient to enable the leader device 1002 to complete physical medium attachment layer training, regardless of the specific training signal designation employed.

At a step 1018, the follower device 1004 transmits a normal data signal to the leader device 1002. The normal data signal transmitted at the step 1018 represents the transition from the synchronization and training phases to normal data transmission. Dashed lines in the link synchronization diagram 1000 indicate the step 1018, showing continuation of the process into the data transmission phase. Following the step 1018, both the leader device 1002 and the follower device 1004 have completed link synchronization and may proceed with bidirectional data communication.

The closed-loop acknowledgment mechanism illustrated in the link synchronization diagram 1000 addresses the open-loop feedback present in prior approaches where devices assumed synchronization was complete without confirmation. By transmitting the acknowledgment indication at the step 1010, the leader device 1002 notifies the follower device 1004 of successful receipt of the link synchronization signal. The follower device 1004 monitors the information field transmitted by the leader device 1002 and, upon detecting the bit transition indicating acknowledgment, confirms that the leader device 1002 has received the link synchronization signal and proceeds accordingly. The controller of the follower device 1004 proceeds with subsequent phases of link establishment upon receiving the acknowledgment indication from the leader device 1002, with the transition to data reception mode occurring after completion of training. The acknowledgment indication comprises a bit transition in an information field that confirms to the follower device 1004 that the leader device 1002 received the synchronization response.

In some embodiments, the leader device 1002 may reduce transmitter output power during link synchronization compared to data mode, as the synchronization signal transmitted at the step 1006 requires detection rather than high-fidelity data recovery. Reducing transmitter output power during link synchronization conserves energy while maintaining sufficient signal strength for the follower device 1004 to detect the training signal and extract clock information.

In some embodiments, the transmitter of the leader device 1002 may employ burst-mode operation where the transmitter maintains continuous transmission for a detection window period followed by a brief quiet period. This burst-mode operation provides a power management variant that maintains effective continuity from the receiver’s perspective. This burst-mode approach is distinct from the sparse signaling with quiet periods used in prior approaches. Sparse signaling transmits brief presence indications separated by extended quiet periods that prevent reliable clock recovery. In contrast, burst-mode operation maintains transmission for a detection window duration sufficient for the receiver to acquire and maintain clock lock, with any intermission selected so that timing recovery remains held or quickly reacquires without loss of effective continuity at the receiver. The detection window period provides sufficient duration for the follower device 1004 to acquire clock lock and detect the training signal. Burst-mode operation can reduce power consumption during extended synchronization periods while maintaining the benefits of continuous signaling for clock recovery.

In some embodiments, the receiver circuitry of the follower device 1004 may operate in a reduced-power monitoring mode during link synchronization, with full receiver power enabled upon initial detection of the synchronization signal. The reduced-power monitoring mode conserves energy while the follower device 1004 monitors for the presence of the training signal from the leader device 1002. Upon detecting the training signal, the receiver circuitry transitions to full power operation to perform clock extraction and signal validation.

FIG. 11 depicts a timing diagram 1100 that represents link synchronization between a leader device and a follower device. The timing diagram 1100 illustrates the temporal relationship of signals that each device transmits during the synchronization process, showing how the devices coordinate their startup and transition to subsequent operational phases such as training and data transmission.

The timing diagram 1100 includes a leader signal timeline 1102 and a follower signal timeline 1104. The leader signal timeline 1102 represents signals that the leader device transmits over time during link synchronization. The follower signal timeline 1104 represents signals that the follower device transmits over time during link synchronization. FIG. 11 arranges these timelines to visualize the temporal coordination between the leader device and the follower device as they progress through link synchronization.

With continued reference to FIG. 11, the leader device transmits a continuous synchronization signal 1108 to the follower device. The timing diagram 1100 labels the continuous synchronization signal 1108 as SEND_T, indicating that the continuous synchronization signal 1108 comprises a training signal that serves both synchronization and training functions. As described previously, the continuous synchronization signal 1108 omits quiet periods between successive synchronization transmissions. The continuous nature of the continuous synchronization signal 1108 enables the follower device to extract clock information despite frequency offsets between the leader device and the follower device. Timing recovery circuitry of the follower device extracts clock information from the continuous synchronization signal 1108 and derives timing to compensate for a frequency offset relative to the leader device.

Upon detecting the continuous synchronization signal 1108, the follower device transmits a synchronization response 1106 to the leader device. The synchronization response 1106 corresponds to a link synchronization signal that indicates, to the leader device, that the follower device has detected the continuous synchronization signal 1108 and is ready to proceed with link establishment. The follower device transmits the synchronization response 1106 using timing derived from clock information that timing recovery circuitry of the follower device extracts from the continuous synchronization signal 1108.

As further shown in FIG. 11, the timing diagram 1100 depicts transitions that occur during the synchronization process. A transition 1110 on the leader signal timeline 1102 indicates where the leader device receives the synchronization response 1106 from the follower device. The transition 1110 represents the progression from initial synchronization toward a training mode, where the leader device acknowledges receipt of the synchronization response 1106 and prepares for subsequent phases of link establishment. After the transition 1110, the leader device continues to transmit training signals, followed by normal data signals as link synchronization progresses.

A transition 1112 on the follower signal timeline 1104 indicates where the follower device transitions from transmitting the synchronization response 1106 to transmitting training signals. The transition 1112 represents the subsequent progression from the synchronization phase toward training mode and data transmission mode. Following the transition 1112, the follower signal timeline 1104 shows the follower device transmitting training signals, followed by normal data signals. The transitions 1110 and 1112 illustrate the coordinated progression of both devices through link synchronization toward training and data transmission modes.

In some embodiments, multiple communication lanes share a common synchronization signal that a designated reference lane transmits, with remaining lanes achieving synchronization by phase-aligning to the reference lane. The designated reference lane transmits the continuous synchronization signal, and the remaining lanes derive timing from the reference lane rather than performing independent clock extraction. This shared synchronization approach reduces the complexity of multi-lane configurations by centralizing timing recovery on a single reference lane.

In some embodiments, each lane performs independent link synchronization with staggered timing to reduce peak power consumption during system startup. The staggered timing staggers transmission of continuous synchronization signals across multiple lanes, preventing simultaneous transmission that would otherwise increase instantaneous power draw. This staggered approach distributes power consumption over time during the link synchronization phase.

In some embodiments, the system supports a daisy-chain topology where a first physical layer device achieves synchronization with a switch and then relays timing information to subsequent physical layer devices in the chain. The first physical layer device receives the continuous synchronization signal from the switch, extracts clock information using timing recovery circuitry, and derives operational timing from the recovered clock. The first physical layer device then regenerates a continuous synchronization signal referenced to the recovered clock and transmits the regenerated signal to a second physical layer device. The regeneration process introduces a retiming latency corresponding to a buffer depth, which is in a range of two symbol periods to sixteen symbol periods depending on implementation requirements and the need to absorb timing variations between the received and transmitted signals. A phase alignment mechanism synchronizes the phase of the regenerated signal to the recovered clock by adjusting transmit timing based on phase detector output, ensuring that the regenerated signal maintains a stable phase relationship with the received signal. The buffer depth is selected to accommodate expected phase variations while minimizing latency, with deeper buffers providing greater tolerance for timing jitter at the cost of increased propagation delay through the daisy-chain. The first physical layer device transmits the regenerated signal to the second physical layer device using the same symbol rate and the same encoding used during data transmission, for example by scrambling zeros with a data-mode scrambler and encoding with the same line code employed on the primary link.

The second physical layer device receives the regenerated continuous synchronization signal from the first physical layer device, acquires clock lock using timing recovery circuitry, and derives its own operational timing from the relayed signal without requiring a direct connection to the switch. In some cases, the first physical layer device forwards timing in a retimed manner, where the recovered clock directly or indirectly clocks the downstream transmitter so that jitter and wander introduced by the upstream channel are not amplified. To bound jitter accumulation across the daisy-chain, each hop is allocated a per-hop jitter budget, such as 0.1 unit intervals to 0.5 unit intervals of additional jitter per hop, and the maximum number of hops in the chain is limited to a range of 2 to 8 hops depending on the cumulative timing error tolerance of the system. The cumulative timing error limit across all hops is specified as a fraction of the symbol period, such as 10 percent to 30 percent of the symbol period, beyond which reliable data recovery at the final device in the chain is compromised. Each physical layer device in the chain monitors its timing recovery lock status and inhibits forwarding of the regenerated signal until stable timing is acquired, preventing propagation of degraded timing through the chain. Each physical layer device in the chain includes a downstream transmitter that regenerates and forwards the continuous synchronization signal to a next physical layer device, allowing each subsequent physical layer device to extract clock information and achieve synchronization from the relayed signal.

The daisy-chain topology thereby enables synchronization of multiple physical layer devices through a single communication path from the switch, reducing wiring complexity in multi-device installations by eliminating separate home-run connections from each physical layer device to the switch. Additional implementations include per-hop equalization and pre-emphasis tailored to the local cable segment, loss-of-signal or loss-of-lock detection that inhibits forwarding until the device acquires stable timing, and optional propagation of acknowledgment or status indications upstream and downstream so that devices in the chain can coordinate training and transition to data transmission while maintaining continuous synchronization signaling characteristics at each hop.

Referring to FIG. 12, a link synchronization process 1200 illustrates a communication sequence between a leader device 1202 (which may be an implementation or example of leader device 100) and a follower device 1204 (which may be an implementation or example of follower device 200). The link synchronization process 1200 depicts the exchange of signals between the leader device 1202 and the follower device 1204 to establish synchronization and enable subsequent data transmission. The link synchronization process 1200 includes a closed-loop acknowledgment mechanism that confirms successful receipt of synchronization responses, addressing synchronization failures that could otherwise occur when channel noise corrupts acknowledgments in open-loop approaches.

The link synchronization process 1200 begins at a step 1206, where the leader device 1202 transmits a training signal to the follower device 1204. The training signal transmitted at the step 1206 comprises a continuous synchronization signal that omits quiet periods between successive synchronization transmissions. The training signal at the step 1206 enables the follower device 1204 to extract clock information and derive timing to compensate for a frequency offset relative to the leader device 1202. Timing recovery circuitry of the follower device 1204 acquires clock lock from the training signal, enabling the follower device 1204 to synchronize with the leader device 1202 despite frequency offsets that may exist in configurations where clock variations between communicating devices are substantial, such as 10 percent to 20 percent or more.

With continued reference to FIG. 12, at a step 1208, the follower device 1204 transmits a link synchronization signal to the leader device 1202 in response to detecting the training signal from the step 1206. The link synchronization signal transmitted at the step 1208 indicates that the follower device 1204 has detected the training signal from the leader device 1202 and is ready to proceed with link establishment. The follower device 1204 transmits the link synchronization signal using timing derived from clock information extracted from the training signal received at the step 1206.

At a step 1210, the leader device 1202 transmits an acknowledgment indication combined with an enable slave transmit indication to the follower device 1204. The acknowledgment indication transmitted at the step 1210 confirms to the follower device 1204 that the leader device 1202 successfully received the link synchronization signal from the step 1208. The acknowledgment indication comprises a bit transition in an information field that the leader device 1202 transmits, thereby providing closed-loop feedback to the follower device 1204. The enable slave transmit indication transmitted at the step 1210 signals to the follower device 1204 that the leader device 1202 is ready for the follower device 1204 to begin transmitting. Upon detecting the acknowledgment indication, the follower device 1204 proceeds with subsequent phases of link establishment.

As further shown in FIG. 12, at a step 1212, the follower device 1204 transmits a follower training signal to the leader device 1202. The follower training signal transmitted at the step 1212 enables the leader device 1202 to perform training operations, including clock and data recovery acquisition, timing recovery, equalizer training, and echo cancellation. The follower training signal at the step 1212 provides the leader device 1202 with a signal from which the leader device 1202 completes physical medium attachment layer training.

At a step 1214, the follower device 1204 transmits a normal data signal to the leader device 1202. The normal data signal transmitted at the step 1214 represents the transition from synchronization and training phases to normal data transmission. Following the step 1214, both the leader device 1202 and the follower device 1204 have completed link synchronization and proceed with bidirectional data communication.

The closed-loop acknowledgment mechanism illustrated in the link synchronization process 1200 eliminates the open-loop feedback present in prior approaches where devices assumed synchronization was complete without confirmation. In prior approaches, a first device would transmit a synchronization signal, a second device would respond with an acknowledgment, and the first device would assume synchronization was complete without confirming receipt of the acknowledgment. If channel noise corrupted the acknowledgment, the first device would remain waiting while the second device proceeded, causing a synchronization failure. To address scenarios where channel noise corrupts the acknowledgment indication transmitted by the leader device 1202, the follower device 1204 implements a timeout mechanism and retry logic. If the follower device 1204 does not detect the acknowledgment indication within an expected time window, such as 10 milliseconds to 100 milliseconds, the follower device 1204 retransmits the link synchronization signal and awaits a subsequent acknowledgment indication. In some embodiments, the acknowledgment indication employs multi-bit redundancy, where the leader device 1202 sets multiple bits in the information field to indicate acknowledgment, thereby reducing the probability that channel noise corrupts all acknowledgment bits simultaneously. In other embodiments, the leader device 1202 transmits the acknowledgment indication repeatedly across multiple consecutive information fields, enabling the follower device 1204 to detect the acknowledgment even if noise corrupts one or more transmissions. By transmitting the acknowledgment indication at the step 1210, the leader device 1202 notifies the follower device 1204 of successful receipt of the link synchronization signal. The follower device 1204 monitors the information field that the leader device 1202 transmits and, upon detecting the bit transition indicating acknowledgment, confirms that the leader device 1202 has received the link synchronization signal and proceeds accordingly.

In some embodiments, the leader device increases the continuous synchronization signal amplitude for longer cable lengths to provide an adequate signal-to-noise ratio at the receiver for reliable detection. The increased amplitude compensates for signal attenuation that occurs over longer cable lengths. This compensation maintains sufficient signal strength at the follower device for the timing recovery circuitry to extract clock information and for the detector to validate the received synchronization signal.

In some embodiments, the system automatically adjusts the detection threshold based on a measured or estimated cable attenuation value determined during an initial probing phase. During the initial probing phase, the system measures characteristics of the communication channel and adjusts the detection threshold based on the measured cable attenuation to optimize detection sensitivity for the specific cable length and attenuation characteristics. This automatic adjustment facilitates reliable detection across a range of cable configurations without requiring manual threshold configuration.

In some embodiments, the continuous synchronization signal employs pre-emphasis or de-emphasis to compensate for frequency-dependent cable losses, improving detection reliability across a range of cable types and lengths. Pre-emphasis increases the amplitude of high-frequency components of the transmitted signal to compensate for frequency-dependent attenuation in the cable. De-emphasis reduces the amplitude of high-frequency components at the receiver to match the expected signal characteristics. The pre-emphasis or de-emphasis compensation facilitates the timing recovery circuitry of the follower device extracting clock information from the continuous synchronization signal despite frequency-dependent cable losses that would otherwise distort the received signal.

In addition to cable length compensation, the system may adjust the link synchronization parameters to compensate for temperature variations and environmental conditions that affect oscillator frequency and signal propagation. Temperature changes during operation cause oscillator frequency drift, which affects the frequency offset between communicating devices and impacts the reliability of clock recovery during link synchronization. The system dynamically adjusts the frequency offset tolerance based on a temperature sensor reading by adjusting timing recovery loop bandwidth, acquisition range, or pull-in range parameters. A temperature sensor coupled to the physical layer device provides temperature measurements to a controller, which adjusts the frequency offset tolerance based on the measured temperature. At temperature extremes, where oscillator drift is expected to be greater due to the temperature sensitivity of oscillator components, the controller widens the acceptable frequency offset tolerance by increasing the timing recovery loop bandwidth, such as from a nominal value of 50 kHz to an extended value of 200 kHz, and by expanding the pull-in range of the frequency acquisition process, such as from a nominal range of plus or minus 15 percent to an extended range of plus or minus 25 percent. For example, when the temperature sensor indicates that the operating temperature has increased beyond a first predetermined threshold or decreased below a second predetermined threshold, the controller increases the frequency offset tolerance from a nominal value to an extended value that accommodates the expected increase in oscillator frequency drift at the temperature extreme. Conversely, when the temperature sensor indicates that the operating temperature is within a nominal range, the controller applies a narrower frequency offset tolerance, which improves synchronization speed or reduces power consumption in the timing recovery circuitry. The dynamic adjustment of frequency offset tolerance based on temperature sensor readings facilitates the link synchronization process maintaining reliability across the operating temperature range of the physical layer device without requiring fixed worst-case tolerance settings that would otherwise apply regardless of actual operating conditions.

The controller may adjust the detection threshold based on ambient temperature to compensate for temperature-dependent receiver sensitivity variations. Receiver sensitivity varies with temperature due to temperature-dependent characteristics of analog front-end components, which affects the signal-to-noise ratio at the detector and the reliability of synchronization signal detection. The controller receives ambient temperature information from a temperature sensor and adjusts the detection threshold applied by the detector based on the ambient temperature. At elevated temperatures where receiver sensitivity is reduced, the controller lowers the detection threshold to maintain detection reliability despite the reduced signal-to-noise ratio. At lower temperatures where receiver sensitivity is increased, the controller raises the detection threshold to reduce the probability of false detection due to noise. The temperature-based adjustment of detection thresholds facilitates the detector maintaining consistent detection performance across the operating temperature range, compensating for temperature-dependent variations in receiver sensitivity that would otherwise affect synchronization reliability.

The system may perform periodic re-synchronization during operation to compensate for frequency drift caused by temperature changes over time. During extended operation, temperature changes cause gradual drift in oscillator frequency, which can accumulate and affect the timing alignment between communicating devices. Periodic re-synchronization involves the physical layer devices re-executing portions of the link synchronization process at intervals during operation to re-establish timing alignment and compensate for accumulated frequency drift. The system performs the periodic re-synchronization without interrupting data transmission by using dedicated time intervals interleaved with data transmission, by performing re-synchronization concurrently with data reception using the same timing recovery circuitry that operates during both synchronization and data transmission phases, or by employing a time-multiplexing scheme where brief re-synchronization intervals are scheduled during inter-frame gaps or idle periods in the data stream. In some embodiments, the timing recovery circuitry continuously tracks and corrects frequency drift during data reception, and the periodic re-synchronization comprises a verification that the timing recovery circuitry remains within acceptable lock parameters, with a full re-acquisition triggered only if the verification indicates degradation beyond a threshold. The system triggers the periodic re-synchronization based on elapsed time since the previous synchronization, based on detected degradation in received signal quality, or based on temperature change magnitude since the previous synchronization. During periodic re-synchronization, the timing recovery circuitry re-acquires clock information from the continuous synchronization signal to update the derived timing and compensate for frequency drift that has occurred since the previous synchronization. Periodic re-synchronization facilitates the link maintaining timing alignment over extended operation despite temperature-induced frequency drift that would otherwise accumulate and degrade communication reliability.

In some embodiments, the link synchronization process includes diagnostic and status reporting features for system monitoring and troubleshooting. A diagnostic module measures the magnitude of the detected frequency offset during link synchronization. The system may implement the diagnostic module as a function within the controller or as dedicated diagnostic circuitry coupled to the timing recovery circuitry. The timing recovery circuitry extracts clock information from the continuous synchronization signal and derives timing to compensate for the frequency offset relative to the remote device. During this process, the diagnostic module determines the magnitude of the frequency offset based on the adjustment applied by the timing recovery circuitry to achieve clock lock. The diagnostic module reports the measured frequency offset magnitude to a system management interface for logging or analysis. The system management interface comprises a register accessible by a host processor, a dedicated diagnostic port, or a communication interface that provides access to diagnostic information. The frequency offset magnitude measurement facilitates operators or automated systems assessing the clock accuracy of communicating devices and identifying devices with oscillators exhibiting drift beyond expected tolerances. In crystal-less configurations where frequency offsets reach 20 percent or more, the frequency offset magnitude measurement provides visibility into the actual operating conditions of the communication link.

The system may further record the number of synchronization attempts before achieving successful synchronization. Each time the physical layer device initiates a synchronization attempt and fails to achieve synchronization within an expected time window or due to detection failure, the system increments a counter. Upon successful synchronization, the system stores the counter value representing the number of synchronization attempts in a diagnostic register or reports it to the system management interface. Additionally, the system logs the elapsed time from the initiation of the synchronization process to successful completion. The system starts a timer when the physical layer device begins transmitting or monitoring for the continuous synchronization signal, and the system records the timer value when synchronization is successfully achieved. The system makes the recorded number of synchronization attempts and the time to achieve synchronization available for diagnostic purposes through the system management interface. This information facilitates operators assessing system performance, identifying communication links that involve multiple attempts to synchronize, and detecting degradation in link quality over time.

In some embodiments, the system maintains a history of synchronization failures and their causes to facilitate identification of intermittent connectivity issues. The history includes records of synchronization failures categorized by cause, such as timeout failures where the system did not receive the expected response within a predetermined time window, detection failures where the receiver did not successfully detect the continuous synchronization signal, or acknowledgment failures where the follower device did not receive the closed-loop acknowledgment indication. Each failure record includes a timestamp indicating when the failure occurred, the identified cause of the failure, and additional contextual information such as the measured signal level or the number of symbols that matched during detection validation. The system stores the failure history in non-volatile memory to preserve the records across power cycles, or stores the failure history in volatile memory and reports it to the system management interface before power-down. The system management interface provides access to the failure history for troubleshooting and preventive maintenance. By analyzing the failure history, operators identify patterns such as recurring failures at specific times, failures correlated with temperature changes, or failures associated with particular communication links. The failure history facilitates identification of intermittent connectivity issues that are not apparent from single-event diagnostics, supporting proactive maintenance and reliability improvement of the communication system.

In some embodiments, the system maintains backward compatibility with remote devices that employ quartz crystal oscillators for clock generation. A controller of a physical layer device automatically detects whether a connected remote device operates in a crystal-based mode or a crystal-less mode by analyzing timing characteristics of received signals during an initial connection phase. The timing characteristics analyzed include frequency stability measurement over a measurement duration, such as 1 millisecond to 10 milliseconds, where the controller measures the variance or standard deviation of the received signal frequency. When the controller detects that the received signal exhibits frequency stability consistent with a quartz crystal oscillator, such as frequency variations within a few hundred parts per million, the controller determines that the remote device operates in crystal-based mode. Conversely, when the controller detects that the received signal exhibits frequency variations consistent with crystal-less operation, such as frequency offsets approaching or exceeding 10 percent, the controller determines that the remote device operates in crystal-less mode. A variance threshold distinguishing crystal-based from crystal-less operation may be set at a frequency variation of approximately 1 percent, below which the controller classifies the remote device as crystal-based and above which the controller classifies the remote device as crystal-less. Based on the detected mode of the remote device, the controller adjusts detection parameters, including the bandwidth of timing recovery circuitry, detection thresholds, or acquisition algorithms appropriate for the detected frequency offset range.

In some embodiments, the system supports a negotiation phase where the local device and the remote device exchange capability information and agree on a synchronization method to be used. During the negotiation phase, each device transmits capability information indicating a clock generation configuration of the device, such as whether the device employs a quartz crystal oscillator or operates in a crystal-less configuration. The capability information may further indicate supported frequency offset tolerance ranges, available synchronization protocols, or preferred synchronization parameters. The local device and the remote device exchange the capability information through dedicated fields in synchronization signals or through a separate capability exchange protocol executed prior to or during the link synchronization phase. Based on the exchanged capability information, the devices agree on a synchronization method that accommodates the clock generation configurations of both devices. For example, when both devices indicate crystal-based operation with tight frequency tolerances, the devices may agree to use synchronization parameters optimized for low frequency offset scenarios. When one or both devices indicate crystal-less operation, the devices may agree to use synchronization parameters that accommodate larger frequency offsets, such as wider timing recovery loop bandwidths or extended acquisition durations.

In some embodiments, the system uses a continuous signaling approach universally for both crystal-based and crystal-less configurations, simplifying system design while maintaining compatibility across device generations. By employing continuous synchronization signaling regardless of whether the local device or the remote device uses a quartz crystal oscillator, the system reduces the need for mode-specific synchronization protocols or hardware configurations. The continuous synchronization signal facilitates the timing recovery circuitry at the receiving device extracting clock information and deriving timing whether the frequency offset between devices is small, as in crystal-based configurations, or large, as in crystal-less configurations. This universal application of continuous signaling facilitates a single hardware architecture and synchronization protocol supporting communication links between crystal-based devices, between crystal-less devices, or between a crystal-based device and a crystal-less device. The universal continuous signaling approach simplifies system design by reducing conditional logic or mode selection based on clock generation configuration and maintains compatibility across device generations as systems transition from crystal-based to crystal-less implementations.

In some embodiments, when the controller determines that the remote device operates in a crystal-based mode, the controller applies parameter values tailored for small frequency offsets. These parameter values may include a timing recovery loop bandwidth between one thousand hertz and ten thousand hertz, an acquisition time window between one millisecond and ten milliseconds, and a detection correlation threshold between 0.95 and 0.99. When the controller determines that the remote device operates in a crystal-less mode, the controller applies parameter values that accommodate larger frequency offsets. These parameter values may include a timing recovery loop bandwidth between fifty thousand hertz and five hundred thousand hertz, an acquisition time window between ten milliseconds and two hundred milliseconds, and a detection correlation threshold selected to balance noise immunity and rapid acquisition, for example between 0.85 and 0.95. In some cases, the controller limits the frequency offset search range to within one percent for crystal-based operation and widens it to at least twenty percent or more for crystal-less operation. In some cases, the controller reduces symbol validation window length, for example to eight to sixteen symbols for crystal-based operation, and increases it, for example to sixteen to sixty-four symbols for crystal-less operation. Additional parameters that the controller may adjust include loop damping factor, slew rate limits for phase correction, and decision-directed enable thresholds.

In some embodiments, the capability information exchanged during a negotiation phase includes a structured set of fields. The capability information may include a device identity field, a clock generation type field having enumerated values indicating quartz crystal oscillator or crystal-less oscillator, a supported frequency offset tolerance range field indicating minimum and maximum percentage values, and one or more synchronization method identifiers indicating supported synchronization protocols. The capability information may further include a preferred parameter set comprising a timing recovery loop bandwidth range expressed in hertz, an acquisition time window expressed in milliseconds, a detection correlation threshold, and an indication of whether closed-loop acknowledgment is supported. Optional fields may include a preferred encoding scheme, a maximum transmit amplitude during synchronization, supported power management modes during synchronization, a multi-lane reference lane designation where applicable, and vendor-specific extensions. The fields may be conveyed as fixed-length or variable-length values and may include versioning to support evolution over time.

In some embodiments, mixed-mode networks comprise a coordinator that communicates concurrently with a plurality of remote devices where some devices operate in crystal-based mode and other devices operate in crystal-less mode. The coordinator performs capability exchange and parameter selection on a per-link basis so that the coordinator synchronizes each link using parameters appropriate to the linked devices, while continuous signaling provides a common baseline across the network. In some cases, devices advertise timing leadership preferences so that the system confines links involving wide acquisition ranges to segments that can accommodate them, while other links use narrow acquisition ranges for faster startup. In some cases, the coordinator staggers synchronization events across links to manage instantaneous power draw and electromagnetic emissions in heterogeneous deployments. In daisy-chain or relay arrangements, an intermediate device may retime and translate between parameter sets, forwarding timing with characteristics suitable for the downstream device while maintaining acknowledgment semantics end-to-end.

In some embodiments, when negotiation fails or when devices advertise incompatible capabilities, the system employs fallback mechanisms that maintain interoperability while degrading gracefully. A device reverts to a default parameter profile expected to interoperate broadly, comprising continuous synchronization signaling at a data-mode symbol rate, a timing recovery loop bandwidth in a range of 10 kHz to 100 kHz, an acquisition time window in a range of 50 milliseconds to 200 milliseconds, and a detection correlation threshold of 0.9. In some cases, the device attempts a sequence of predefined parameter profiles in a deterministic order until synchronization succeeds or a timeout occurs. In some cases, the system disables advanced features such as adaptive encoding selection or bidirectional status fields while core continuous signaling and acknowledgment remain enabled. In further cases, the system reduces data rate, increases training duration, or schedules periodic reattempts while recording diagnostic information so that operation continues in a reduced-capability mode until the devices establish compatible parameters.

As may be clear from the foregoing disclosure, embodiments of the present disclosure provide many benefits in comparison to conventional or traditional options. Embodiments of the present disclosure provide methods and apparatus for link synchronization in communication link systems where clock variations may be substantial. A continuous synchronization signal that a low data rate transmitter transmits enables the timing recovery circuitry at a receiving device to extract clock information and derive timing despite frequency offsets of 10 percent or more, and up to 20 percent or more in some implementations. The continuous signal allows the same circuitry used for timing recovery in data mode to perform clock extraction and timing derivation during link synchronization, which may eliminate the need for dedicated link synchronization detection hardware. This is particularly advantageous on the camera side where resources are constrained, and a specialized detector would be expensive to implement.

Additionally, the system may combine link synchronization and training using unified signal framing, where a training signal substitutes for the synchronization signal, enabling a single signal structure for both functions and eliminating a separate quiet period between synchronization and training phases. The unified approach enables identical hardware for link synchronization, training, and data modes, reducing implementation complexity and cost while enabling faster link establishment.

Throughout the foregoing Detailed Description, the following terminology and conventions have been used: The term “configured to” describes hardware, software, firmware, or combinations thereof arranged, programmed, or otherwise provisioned to perform a stated function. It refers to capability resulting from structure and/or programming, not mere intended use. The term “coupled” indicates direct or indirect interaction, association, or communication (for example, electrical, logical, data, or signal coupling), with or without intervening elements. Wired and wireless connections are included unless the specification specifies otherwise. The terms “about” or “approximately” indicate a value within normal engineering, measurement, or numerical tolerance for the context. Unless otherwise specified, “about” may encompass plus or minus 10% of the stated value or a tolerance appropriate to the resolution or precision stated. Numeric ranges are inclusive of endpoints and include all subranges and intermediate values. Where a range is recited with “about,” the approximation applies to endpoints and intermediate values unless otherwise indicated. Terms such as “optional,” “optionally,” and “may” indicate that a feature, step, or parameter can be present or absent, enabled or disabled, without implying that alternatives are excluded. Optional features can be used individually or in any combination.

Reference numerals and figure conventions have been applied as follows: The same reference numeral refers to the same or functionally equivalent element across figures. Suffixes (such as 304a, 304b) or primes may denote variants, instances, or related elements. Drawings are schematic and not necessarily to scale unless the specification expressly indicates otherwise. Relative sizes and spatial relationships may be exaggerated for clarity. Block diagrams depict functionality and/or logical groupings; a single block may represent multiple components or functions, and multiple blocks may be implemented within a single component. Flowchart steps may be performed in different orders, in parallel, iteratively, and/or with steps added or omitted, unless a particular order is expressly required.

Units and coordinate systems have been used as follows: International System of Units (Système International d’Unités, SI) units are used unless stated otherwise. Frequencies are in hertz (Hz); time is expressed in seconds (s) or derivatives; data rates may be expressed in bits per second or baud. Signal timing diagrams are illustrative and not necessarily to scale; references to “leader/follower,” “master/slave,” “upstream/downstream,” or “transmit/receive” indicate signal flow directionality, not physical orientation.

Cross-references to figures have been provided for illustrative context (for example, “FIG. 1”). Figure numbers do not imply priority, sequence, or exclusivity. Components shown in different figures can be combined or substituted as technically appropriate.

These conventions apply throughout the Detailed Description, including descriptions of leader devices, follower devices, transmitters, receivers, timing recovery circuitry, detectors, PRBS generators, controllers, continuous synchronization signals, synchronization responses, and acknowledgment indications, and to their variants and equivalents.

The foregoing description has set forth exemplary aspects of the present disclosure. It should be recognized, however, that such description does not limit the scope of the present disclosure. Rather, the description also encompasses combinations and modifications to those exemplary aspects described herein. A number of implementations have been described. Nevertheless, it will be understood that various modifications may be made without departing from the spirit and scope of the disclosure. Accordingly, other implementations are within the scope of the following claims.

What is claimed is:

1. A method comprising:
receiving, by a first physical layer device, a continuous synchronization signal from a second physical layer device, wherein the continuous synchronization signal omits quiet periods between successive synchronization transmissions;
extracting, by the first physical layer device, clock information from the continuous synchronization signal;
deriving, by the first physical layer device, timing from the continuous synchronization signal to compensate for a frequency offset relative to the second physical layer device; and
transmitting, by the first physical layer device, a synchronization response to the second physical layer device using timing derived from the extracted clock information.

2. The method of claim 1, further comprising receiving, by the first physical layer device, an acknowledgment indication from the second physical layer device upon successful receipt of the synchronization response, the acknowledgment indication confirming to the first physical layer device that the synchronization response was received.

3. The method of claim 2, wherein:
the acknowledgment indication comprises a bit transition in an information field transmitted by the second physical layer device; and
the method further comprises transitioning, by the first physical layer device, to a data mode upon receiving the acknowledgment indication.

4. The method of claim 1, wherein the first physical layer device is configured to receive data at a first data rate and transmit data at a second data rate higher than the first data rate, and the second physical layer device is configured to transmit data at the first data rate and receive data at the second data rate.

5. The method of claim 4, further comprising transmitting, by the first physical layer device, a training signal to the second physical layer device, wherein the training signal enables the second physical layer device to complete physical medium attachment layer training.

6. The method of claim 1, wherein the first physical layer device performs a coarse detection phase to identify a potential synchronization signal followed by a fine detection phase to validate the continuous synchronization signal before transmitting the synchronization response.

7. The method of claim 6, further comprising:
seeding, by the first physical layer device, a local pseudo-random binary sequence generator with an initial sequence of symbols captured from the continuous synchronization signal; and
comparing predicted symbols generated by the local pseudo-random binary sequence generator against subsequently received symbols to validate the continuous synchronization signal.

8. The method of claim 1, wherein the first physical layer device comprises timing recovery circuitry that extracts the clock information and derives timing at a frequency offset up to a frequency offset tolerance relative to the second physical layer device.

9. The method of claim 8, wherein the first physical layer device lacks a local crystal oscillator and derives operational timing from the continuous synchronization signal.

10. The method of claim 9, wherein the continuous synchronization signal employs differential Manchester encoding.

11. The method of claim 1, wherein the continuous synchronization signal comprises a training signal that comprises scrambled zeros and serves both synchronization and training functions.

12. The method of claim 11, wherein the continuous synchronization signal comprises scrambled zeros encoded using at least one of:
differential Manchester encoding;
pulse amplitude modulation with two levels (PAM-2);
pulse amplitude modulation with three levels (PAM-3); or
pulse amplitude modulation with four levels (PAM-4).

13. The method of claim 12, wherein the continuous synchronization signal employs a symbol rate equal to a symbol rate used during data transmission.

14. An apparatus comprising:
a first physical layer device, the first physical layer device comprising:
a receiver configured to receive a continuous synchronization signal from a second physical layer device, wherein the continuous synchronization signal omits quiet periods between successive synchronization transmissions;
timing recovery circuitry configured to extract clock information from the continuous synchronization signal and to derive timing from the continuous synchronization signal to compensate for a frequency offset relative to the second physical layer device, wherein the timing recovery circuitry is configured to perform clock extraction during both synchronization and data transmission phases; and
a transmitter configured to transmit, using timing derived from the extracted clock information, a synchronization response to the second physical layer device.

15. The apparatus of claim 14, wherein the apparatus derives operational timing from the continuous synchronization signal.

16. The apparatus of claim 15, further comprising a detector configured to seed a local pseudo-random binary sequence generator with an initial sequence of symbols captured from the continuous synchronization signal and compare predicted symbols generated by the local pseudo-random binary sequence generator against subsequently received symbols.

17. The apparatus of claim 14, further comprising a controller configured to transition to a data mode upon receiving an acknowledgment indication from the second physical layer device upon successful receipt of the synchronization response, wherein the acknowledgment indication comprises a bit transition in an information field and confirms that the synchronization response was received.

18. An apparatus comprising:
a transmitter configured to transmit a continuous synchronization signal to a first physical layer device, wherein the continuous synchronization signal omits quiet periods between successive synchronization transmissions;
a receiver configured to receive a synchronization response from the first physical layer device; and
a controller configured to cause transmission of an acknowledgment indication to the first physical layer device upon successful receipt of the synchronization response, the acknowledgment indication confirming to the first physical layer device that the synchronization response was received.

19. The apparatus of claim 18, wherein the continuous synchronization signal employs a symbol rate equal to a symbol rate used during data transmission.

20. The apparatus of claim 19, wherein the transmitter further comprises:
a data-mode scrambler configured to scramble zeros; and
a differential encoder configured to encode output from the data-mode scrambler using differential Manchester encoding.
